(19) United States
(12) Patent Application Publication
(10) Pub. No.: US 2015/0240161 A1
(43) Pub. Date: Aug. 27, 2015

(54) LIQUID CRYSTAL COMPOSITION AND LIQUID CRYSTAL DISPLAY DEVICE

(71) Applicants: JNC CORPORATION, Tokyo (JP); JNC PETROCHEMICAL CORPORATION, Tokyo (JP)

(72) Inventors: NAOKO MANABE, CHIBA (JP); MASAYUKI SAITO, CHIBA (JP); YOSHIMASA FURUSATO, CHIBA (JP)

(21) Appl. No.: 14/602,291

(22) Filed: Jan. 22, 2015

(30) Foreign Application Priority Data
Feb. 25, 2014 (JP) 2014-033989

(51) Int. Cl. C09K 19/34; C09K 19/54; C09K 19/30

(52) U.S. Cl. CPC C09K 19/3402; C09K 19/3066; C09K 19/3068; C09K 19/542; C09K 2019/3422; C09K 2019/3071; C09K 2019/548; C09K 2019/3425

(57) ABSTRACT

To provide a liquid crystal composition having at least one or suitable balance regarding at least two of characteristics such as a wide nematic phase temperature range, small viscosity, suitable optical anisotropy, large negative dielectric anisotropy or specific resistance, high stability to ultraviolet light or heat; and an AM device having short response time, a large voltage holding ratio, low threshold voltage, a large contrast ratio and a long life. The composition has negative dielectric anisotropy and contains a compound having small viscosity as a first component, a compound having methyleneoxy and large negative dielectric anisotropy as a second component, and a compound having large optical anisotropy and negative dielectric anisotropy as a third component, and may contain a compound having high maximum temperature or small viscosity as a fourth component, a compound having large negative dielectric anisotropy as a fifth component, and a polymerizable compound as an additive component.

### CROSS-REFERENCE TO RELATED APPLICATIONS

This application claims the priority benefit of Japan application serial no. 2014-033989, filed on Feb. 25, 2014. The entirety of the above-mentioned patent application is hereby incorporated by reference herein and made a part of this specification.

### BACKGROUND OF THE INVENTION

1. Technical Field

The invention relates to a liquid crystal composition, a liquid crystal display device including the composition and so forth. In particular, the invention relates to a liquid crystal composition having a negative dielectric anisotropy, and a liquid crystal display device that includes the liquid crystal composition and has a mode such as an IPS mode, a VA mode, an FFS mode and an FPA mode. The invention also relates to a liquid crystal display device having a polymer sustained alignment mode.

2. Background Art

In a liquid crystal display device, a classification based on an operating mode for liquid crystals includes a phase change (PC) mode, a twisted nematic (TN) mode, a super twisted nematic (STN) mode, an electrically controlled birefringence (ECB) mode, an optically compensated bend (OCB) mode, an in-plane switching (IPS) mode, a vertical alignment (VA) mode, a fringe field switching (FFS) and a field induced photo-reactive alignment (FPA) mode. A classification based on a driving mode in the device includes a passive matrix (PM) and an active matrix (AM). The PM is classified into static and multiplex and so forth. The AM is classified into a thin film transistor (TFT), a metal insulator metal (MIM) and so forth. The TFT is further classified into amorphous silicon and polycrystal silicon. The latter is classified into a high temperature type and a low temperature type based on a production process. A classification based on a light source includes a reflection type utilizing natural light, a transmissive type utilizing backlight and a transreflective type utilizing both the natural light and the backlight.

The liquid crystal display device includes a liquid crystal composition having a nematic phase. The composition has suitable characteristics. An AM device having good characteristics can be obtained by improving characteristics of the composition. Table 1 below summarizes a relationship of the characteristics between two aspects. The characteristics of the composition will be further described based on a commercially available AM device. A temperature range of the nematic phase relates to a temperature range in which the device can be used. A preferred maximum temperature of the nematic phase is approximately 70° C. or higher, and a preferred minimum temperature of the nematic phase is approximately −10° C. or lower. Viscosity of the liquid crystal composition relates to a response time in the device. A short response time is preferred for displaying moving images on the device. A shorter response time even by one millisecond is desirable. Accordingly, a small viscosity of the composition is preferred. A small viscosity at a low temperature is further preferred.

TABLE 1
General Characteristics of Composition and AM Device

| | General Characteristics | General Characteristics |
|---|---|---|
| No. | of Composition | of AM Device |
| 1 | Wide temperature range of | Wide usable temperature range |
| | a nematic phase | |
| 2 | Small viscosity | Short response time |
| 3 | Suitable optical anisotropy | Large contrast ratio |
| 4 | Large positive or negative | Low threshold voltage and |
| | dielectric anisotropy | small electric power consumption |
| | | Large contrast ratio |
| 5 | Large specific resistance | Large voltage holding ratio and |
| | | large contrast ratio |
| 6 | High stability to ultraviolet | Long service life |
| | light and heat | |
| 7 | Large elastic constant | Large contrast ratio and |
| | | short response time |

An optical anisotropy of the composition relates to a contrast ratio in the device. According to a mode of the device, a large optical anisotropy or a small optical anisotropy, more specifically, a suitable optical anisotropy is required. A product (Δn×d) of the optical anisotropy (Δn) of the composition and a cell gap (d) in the device is designed so as to maximize the contrast ratio. A suitable value of the product depends on a type of the operating mode. The suitable value is in the range of approximately 0.30 micrometer to approximately 0.40 micrometer in a device having the VA mode, and is in the range of approximately 0.20 micrometer to approximately 0.30 micrometer in a device having the IPS mode or the FFS mode. In the above cases, a composition having the large optical anisotropy is preferred for a device having a small cell gap. The large dielectric anisotropy in the composition contributes to a low threshold voltage, a small electric power consumption and a large contrast ratio in the device. Accordingly, the large dielectric anisotropy is preferred. A large specific resistance in the composition contributes to a large voltage holding ratio and the large contrast ratio in the device. Accordingly, a composition having a large specific resistance at room temperature and also at a temperature close to the maximum temperature of the nematic phase in an initial stage is preferred. A composition having a large specific resistance at room temperature and also at a high temperature after the device has been used for a long period of time is preferred. Stability of the composition to ultraviolet light and heat relates to a service life of the liquid crystal display device. In the case where the stability is high, the device has a long service life. Such characteristics are preferred for an AM device used in a liquid crystal projector, a liquid crystal television and so forth.

In a liquid crystal display device having a polymer sustained alignment (PSA) mode, a liquid crystal composition containing a polymer is used. First, a composition to which a small amount of the polymerizable compound is added is injected into the device. Then, the composition is irradiated with ultraviolet light while voltage is applied between substrates of the device. The polymerizable compound polymerizes to form a network structure of the polymer in the liquid crystal composition. In the composition, alignment of liquid crystal molecules can be controlled by the polymer, and therefore a response time in the device is shortened and also image persistence is improved. Such an effect of the polymer can be expected for a device having the mode such as the TN mode, the ECB mode, the OCB mode, the IPS mode, the VA mode, the FFS mode and the FPA mode.

A composition having a positive dielectric anisotropy is used for an AM device having the TN mode. In an AM device having the VA mode, a composition having a negative dielectric anisotropy is used. A composition having a positive or negative dielectric anisotropy is used for an AM device having the IPS mode or the FFS mode. A composition having a positive or negative dielectric anisotropy is used for an AM device having the polymer sustained alignment (PSA) mode. Examples of the liquid crystal compositions having the negative dielectric anisotropy are disclosed in Patent literature No. 1 to No. 5.

Patent literature No. 1: JP 2008-285570 A.

Patent literature No. 2: WO 2006/093102 A.

Patent literature No. 3: WO 2006/064853 A.

Patent literature No. 4: JP 2006-037053 A.

Patent literature No. 5: JP 2006-037054 A.

### SUMMARY OF INVENTION

### Technical Problem

The invention concerns a liquid crystal composition that has a negative dielectric anisotropy and contains at least one compound selected from the group consisting of compounds represented by formula (1) as a first component and at least one compound selected from the group consisting of compounds represented by formula (2) as a second component, and at least one compound selected from the group consisting of compounds represented by formula (3) as a third component, and concerns a liquid crystal display device including the composition:

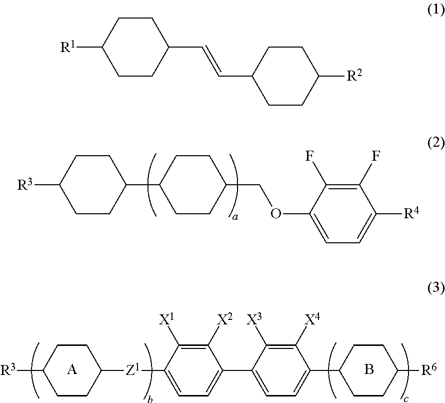

wherein, in formula (1) to formula (3), R¹, R², R³, R⁴, R⁵, and R⁶ are independently alkyl having 1 to 12 carbons, alkoxy having 1 to 12 carbons, alkenyl having 2 to 12 carbons or alkenyloxy having 2 to 12 carbons; ring A and ring B are independently 1,4-cyclohexylene, 1,4-phenylene or tetrahydropyran-2,5-diyl; X¹ and X² are independently hydrogen, fluorine, or chlorine; X³ and X⁴ are independently fluorine or chlorine; Z¹ is a single bond, —CH₂CH₂—, —CH₂O—, —OCH₂—, —COO— or —OCO—; a and c are independently 0 or 1; b is 0, 1, or 2; and a sum of b and c is 0, 1 or 2.

The invention also concerns use of the liquid crystal composition in a liquid crystal display device.

### DESCRIPTION OF EMBODIMENTS

### Technical Problem

One of aims of the invention is to provide a liquid crystal composition satisfying at least one of characteristics such as a high maximum temperature of a nematic phase, a low minimum temperature of the nematic phase, a small viscosity, a suitable optical anisotropy, a large negative dielectric anisotropy, a high specific resistance, a high stability to ultraviolet light and a high stability to heat. Another aim is to provide a liquid crystal composition having a suitable balance regarding at least two of the characteristics. Another aim is to provide a liquid crystal display device including such a composition. Another aim is to provide an AM device having characteristics such as a short response time, a large voltage holding ratio, a low threshold voltage, a large contrast ratio and a long service life.

### Solution to Problem

The invention concerns a liquid crystal composition that has a negative dielectric anisotropy and contains at least one compound selected from the group consisting of compounds represented by formula (1) as a first component and at least one compound selected from the group consisting of compounds represented by formula (2) as a second component, and at least one compound selected from the group consisting of compounds represented by formula (3) as a third component, and concerns a liquid crystal display device including the composition:

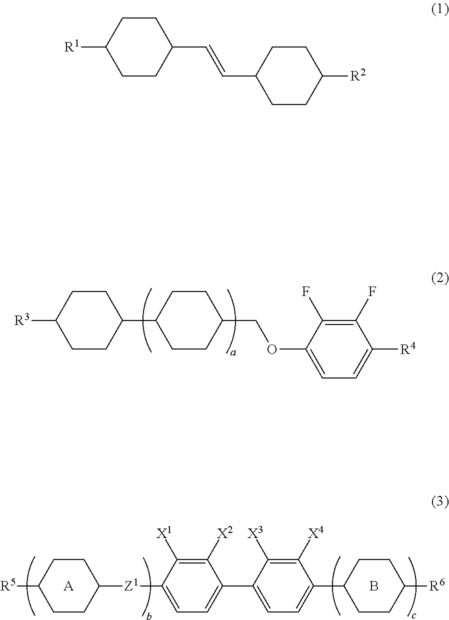

wherein, in formula (1) to formula (3), R¹, R², R³, R⁴, R⁵, and R⁶ are independently alkyl having 1 to 12 carbons, alkoxy having 1 to 12 carbons, alkenyl having 2 to 12 carbons or alkenyloxy having 2 to 12 carbons; ring A and ring B are independently 1,4-cyclohexylene, 1,4-phenylene or tetrahydropyran-2,5-diyl; X¹ and X² are independently hydrogen, fluorine, or chlorine; X³ and X⁴ are independently fluorine or chlorine; Z¹ is a single bond, —CH₂CH₂—, —CH₂O—, —OCH₂—, —COO— or —OCO—; a and c are independently 0 or 1; b is 0, 1, or 2; and a sum of b and c is 0, 1 or 2.

The invention also concerns use of the liquid crystal composition in a liquid crystal display device.

### Advantageous Effects of Invention

An advantage of the invention is a liquid crystal composition satisfying at least one of characteristics such as a high maximum temperature of a nematic phase, a low minimum temperature of the nematic phase, a small viscosity, a large optical anisotropy, a large negative dielectric anisotropy, a high specific resistance, a high stability to ultraviolet light and a high stability to heat. Another advantage thereof is a liquid crystal composition having a suitable balance regarding at least two of the characteristics. Another advantage is a liquid crystal display device including such a composition. Another advantage is an AM device having characteristics such as a short response time, a large voltage holding ratio, a low threshold voltage, a large contrast ratio and a long service life.

Usage of terms herein is as described below. Terms “liquid crystal composition” and “liquid crystal display device” may be occasionally abbreviated as “composition” and “device,” respectively. The liquid crystal display device is a generic term for a liquid crystal display panel and a liquid crystal display module. The liquid crystal compound is a generic term for a compound having a liquid crystal phase such as a nematic phase and a smectic phase, and a compound having no liquid crystal phase but to be mixed with the composition for the purpose of adjusting characteristics such as a temperature range of the nematic phase, viscosity and dielectric anisotropy. The compound has a six-membered ring such as 1,4-cyclohexylene and 1,4-phenylene, and rod-like molecular structure. A polymerizable compound is added for the purpose of forming a polymer in the composition.

The liquid crystal composition is prepared by mixing a plurality of liquid crystal compounds. A ratio (content) of the liquid crystal compounds is expressed in terms of weight percent (% by weight) based on the weight of the liquid crystal composition. An additive such as an optically active compound, an antioxidant, an ultraviolet light absorber, a dye, an antifoaming agent, the polymerizable compound, a polymerization initiator and a polymerization inhibitor is added to the liquid crystal composition when necessary. A ratio (content) of the additive is expressed in terms of weight percent (% by weight) based on the weight of the liquid crystal composition in a manner similar to the ratio of the liquid crystal compound. Weight parts per million (ppm) may be occasionally used. A ratio of the polymerization initiator and the polymerization inhibitor is exceptionally expressed based on the weight of the polymerizable compound.

“Higher limit of the temperature range of the nematic phase” may be occasionally abbreviated as “maximum temperature.” “Lower limit of the temperature range of the nematic phase” may be occasionally abbreviated as “minimum temperature.” An expression “having a large specific resistance” means that the composition has a large specific resistance at room temperature and also at a temperature close to the maximum temperature of the nematic phase in an initial stage, and the composition has a large specific resistance at room temperature and also at a temperature close to the maximum temperature of the nematic phase even after the device has been used for a long period of time. An expression “having a large voltage holding” means that the device has a large voltage holding ratio at room temperature and also at a temperature close to the maximum temperature of the nematic phase in an initial stage, and the device has a large voltage holding ratio at room temperature and also at a temperature close to the maximum temperature of the nematic phase even after the device has been used for the long period of time. An expression “increase the dielectric anisotropy” means that a value of dielectric anisotropy positively increases in a liquid crystal composition having a positive dielectric anisotropy, and the value of dielectric anisotropy negatively increases in a liquid crystal composition having a negative dielectric anisotropy.

An expression “at least one of ‘A’ may be replaced by ‘B’” means that the number of ‘A’ is arbitrary. A position of ‘A’ is arbitrary when the number of ‘A’ is 1, and also positions thereof can be selected without restriction when the number of ‘A’ is two or more. A same rule also applies to an expression “at least one of ‘A’ is replaced by ‘B’.”

A symbol of terminal group R³ is used for a plurality of compounds in chemical formulas of component compounds. In the compounds, two groups represented by two of arbitrary R³ may be identical or different. For example, R³ of compound (2) is ethyl and R³ of compound (2-1) is ethyl. A same rule also applies to a symbol R⁵, R⁴ or the like. In formula (3), when b is 2, two of ring A exist. In the above compounds, two rings represented by two of ring A may be identical or different. A same rule also applies to Z², ring C or the like.

In compound (6), a hexagonal shape represents a ring, and is not necessarily a 6-membered ring. An oblique line crossing the hexagonal shape represents that arbitrary hydrogen on the ring is replaced by a group such as P¹-Sp¹. A subscript such as g represents the number of groups replaced. A case where the subscript is 0 shows no replacement.

Then, 2-fluoro-1,4-phenylene means two divalent groups described below. In the chemical formula, fluorine may be leftward (L) or rightward (R). A same rule also applies to a divalent group in an asymmetrical ring such as tetrahydropyran-2,5-diyl:

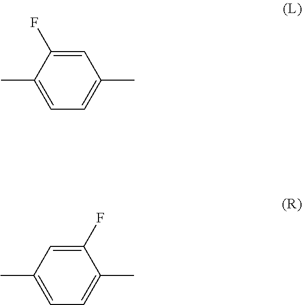

The invention includes the items described below.

Item 1. A liquid crystal composition that has a negative dielectric anisotropy and contains at least one compound selected from the group consisting of compounds represented by formula (1) as a first component, at least one compound selected from the group consisting of compounds represented by formula (2) as a second component, and at least one compound selected from the group consisting of compounds represented by formula (3) as a third component:

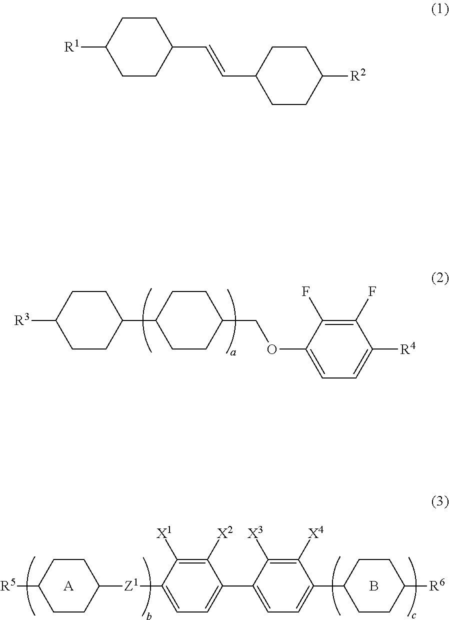

wherein, in formula (1) to formula (3), R¹, R², R³, R⁴, R⁵ and R⁶ are independently alkyl having 1 to 12 carbons, alkoxy having 1 to 12 carbons, alkenyl having 2 to 12 carbons or alkenyloxy having 2 to 12 carbons; ring A and ring B are independently 1,4-cyclohexylene, 1,4-phenylene, or tetrahydropyran-2,5-diyl; X¹ and X² are independently hydrogen, fluorine or chlorine; X³ and X⁴ are independently fluorine or chlorine; Z¹ is a single bond, —CH₂CH₂—, —CH₂O—, —OCH₂—, —COO— or —OCO—; a and c are independently 0 or 1; b is 0, 1 or 2; and a sum of b and c is 0, 1 or 2.

Item 2. The liquid crystal composition according to item 1, containing at least one compound selected from the group consisting of compounds represented by formula (2-1) and formula (2-2) as the second component:

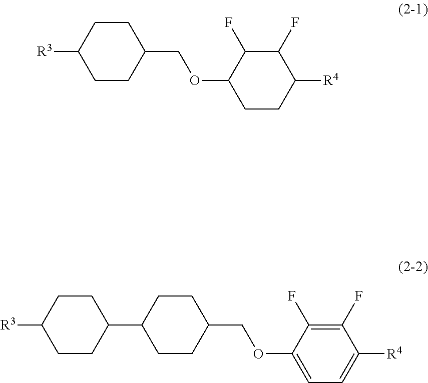

wherein, in formula (2-1) and formula (2-2), R³ and R⁴ are independently alkyl having 1 to 12 carbons, alkoxy having 1 to 12 carbons, alkenyl having 2 to 12 carbons or alkenyloxy having 2 to 12 carbons.

Item 3. The liquid crystal composition according to item 1 or 2, containing at least one compound selected from the group consisting of compounds represented by formula (3-1) to formula (3-7) as the third component:

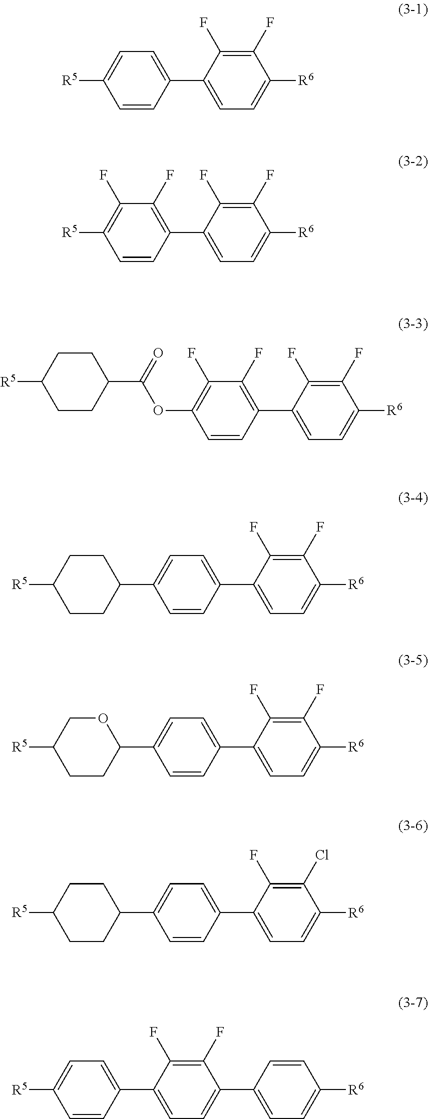

wherein, in formula (3-1) to formula (3-7), R⁵ and R⁶ are independently alkyl having 1 to 12 carbons, alkoxy having 1 to 12 carbons, alkenyl having 2 to 12 carbons or alkenyloxy having 2 to 12 carbons.

Item 4. The liquid crystal composition according to any one of items 1 to 3, wherein a ratio of the first component is in the range of 3% by weight to 30% by weight, a ratio of the second component is in the range of 5% by weight to 50% by weight, and a ratio of the third component is in the range of 3% by weight to 50% by weight, based on the weight of the liquid crystal composition.

Item 5. The liquid crystal composition according to any one of items 1 to 4, containing at least one compound selected from the group consisting of compounds represented by formula (4) as a fourth component:

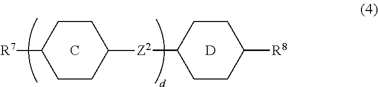

wherein, in formula (4), R⁷ and R⁸ are independently alkyl having 1 to 12 carbons, alkoxy having 1 to 12 carbons, alkenyl having 2 to 12 carbons, alkyl having 1 to 12 carbons in which at least one of hydrogen is replaced by fluorine, or alkenyl having 2 to 12 carbons in which at least one of hydrogen is replaced by fluorine; ring C and ring D are independently 1,4-cyclohexylene, 1,4-phenylene, 2-fluoro-1,4-phenylene or 2,5-difluoro-1,4-phenylene; Z² is a single bond, —CH₂CH₂—, —CH₂O—, —OCH₂—, —COO— or —OCO—; and d is 1, 2 or 3.

Item 6. The liquid crystal composition according to any one of items 1 to 5, containing at least one compound selected from the group consisting of compounds represented by formula (4-1) to formula (4-13) as the fourth component:

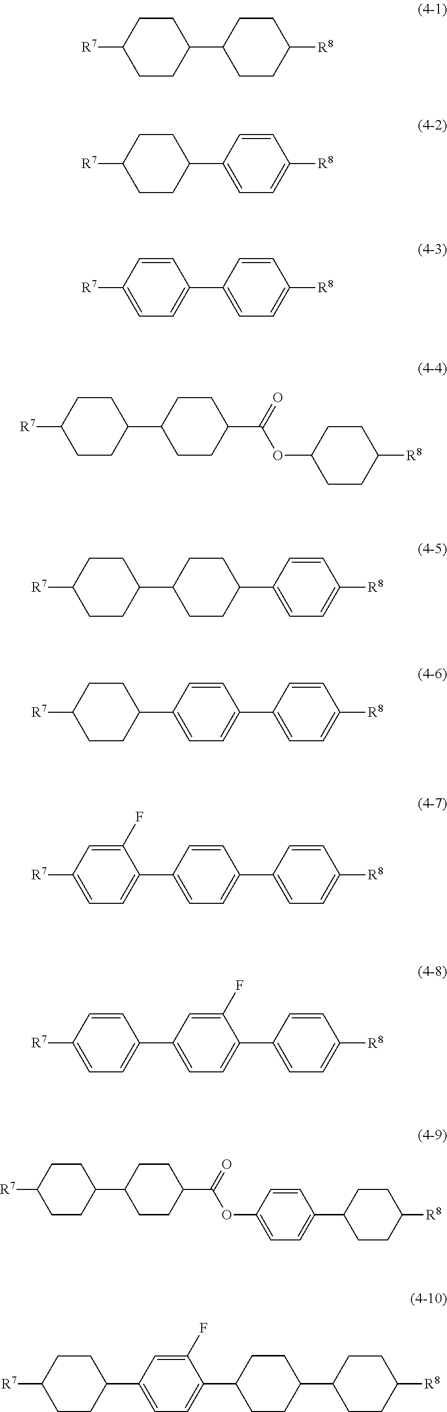

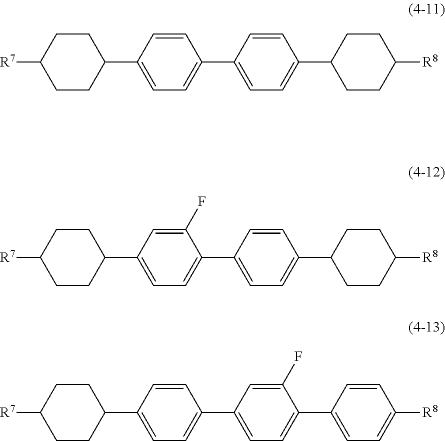

wherein, in formula (4-1) to formula (4-13), R⁷ and R⁸ are independently alkyl having 1 to 12 carbons, alkoxy having 1 to 12 carbons, alkenyl having 2 to 12 carbons, alkyl having 1 to 12 carbons in which at least one of hydrogen is replaced by fluorine, or alkenyl having 2 to 12 carbons in which at least one of hydrogen is replaced by fluorine.

Item 7. The liquid crystal composition according to item 5 or 6, wherein a ratio of the fourth component is in the range of 5% by weight to 80% by weight based on the weight of the liquid crystal composition.

Item 8. The liquid crystal composition according to any one of items 1 to 7, containing at least one compound selected from the group consisting of compounds represented by formula (5) as a fifth component:

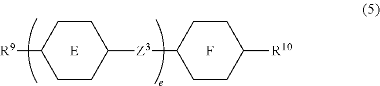

wherein, in formula (5), R⁹ and R¹⁰ are Independently alkyl having 1 to 12 carbons, alkoxy having 1 to 12 carbons, alkenyl having 2 to 12 carbons or alkenyloxy having 2 to 12 carbons; ring E is 1,4-cyclohexylene, 1,4-cyclohexenylene or tetrahydropyran-2,5-diyl; ring F is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl or 7,8-difluorochroman-2,6-diyl; Z³ is a single bond, —CH₂CH₂—, —CH₂O—, —OCH₂—, —COO— or —OCO—; e is 1, 2 or 3; and when ring F is 2,3-difluoro-1,4-phenylene, Z³ is a single bond, —CH₂CH₂—, —COO— or —OCO—.

Item 9. The liquid crystal composition according to any one of items 1 to 8, containing at least one compound selected from the group consisting of compounds represented by formula (5-1) to formula (5-9) as the fifth component:

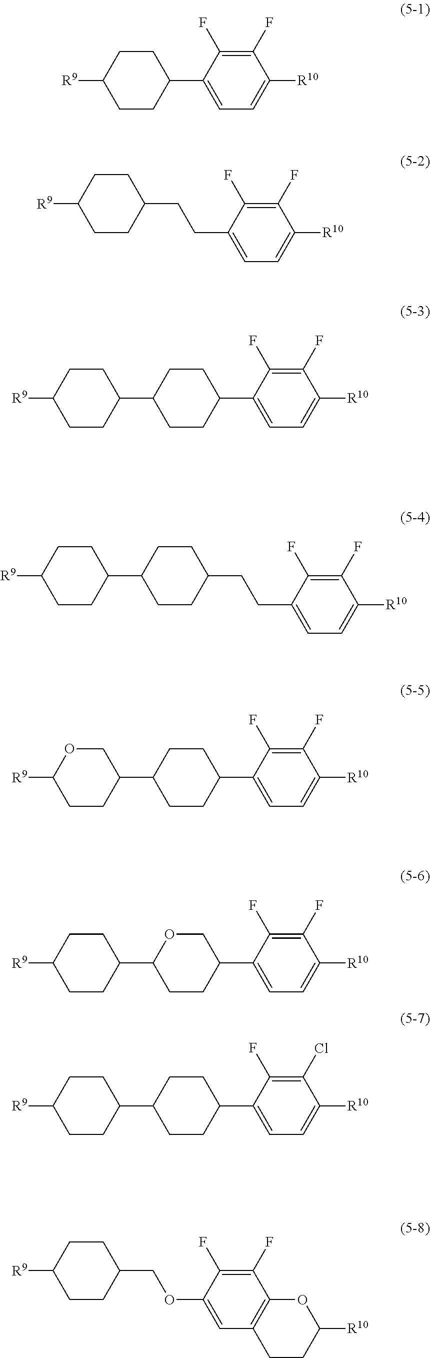

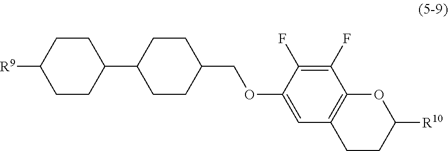

wherein, in formula (5-1) to formula (5-9), R⁹ and R¹⁰ are independently alkyl having 1 to 12 carbons, alkoxy having 1 to 12 carbons, alkenyl having 2 to 12 carbons or alkenyloxy having 2 to 12 carbons.

Item 10. The liquid crystal composition according to item 8 or 9, wherein a ratio of the fifth component is in the range of 3% by weight to 50% by weight based on the weight of the liquid crystal composition.

Item 11. The liquid crystal composition according to any one of items 1 to 10, containing at least one of polymerizable compounds selected from the group consisting of compounds represented by formula (6) as an additive component:

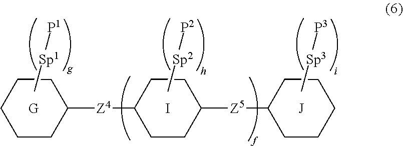

wherein, in formula (6), ring G and ring J are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one of hydrogen may be replaced by halogen, alkyl having 1 to 12 carbons, alkoxy having 1 to 12 carbons, or alkyl having 1 to 12 carbons in which at least one of hydrogen is replaced by halogen; ring I is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one of hydrogen may be replaced by halogen, alkyl having 1 to 12 carbons, alkoxy having 1 to 12 carbons, or alkyl having 1 to 12 carbons in which at least one of hydrogen is replaced by halogen; Z⁴ and Z⁵ are independently a single bond or alkylene having 1 to 10 carbons, and in the alkylene, at least one of —CH₂— may be replaced by —O—, —CO—, —COO— or —OCO—, at least one of —CH₂—CH₂— may be replaced by —CH═CH—, —C(CH₃)═CH—, —CH═C(CH₃)— or —C(CH₃)═C(CH₃)—, and in the groups, at least one of hydrogen may be replaced by fluorine or chlorine; P¹, P² and P³ are a polymerizable group; Sp¹, Sp² and Sp³ are independently a single bond or alkylene having 1 to 10 carbons, and in the alkylene, at least one of —CH₂— may be replaced by —O—, —COO—, —OCO— or —OCOO—, at least one of —CH₂—CH₂— may be replaced by —CH═CH— or —C≡C—, and in the groups, at least one of hydrogen may be replaced by fluorine or chlorine; f is 0, 1 or 2; g, h and i are independently 0, 1, 2, 3 or 4; and a sum of g, h and i is 1 or more.

Item 12. The liquid crystal composition according to item 11, wherein, in formula (6), P¹, P² and P³ are independently a polymerizable group selected from the group consisting of groups represented by formula (P-1) to formula (P-6):

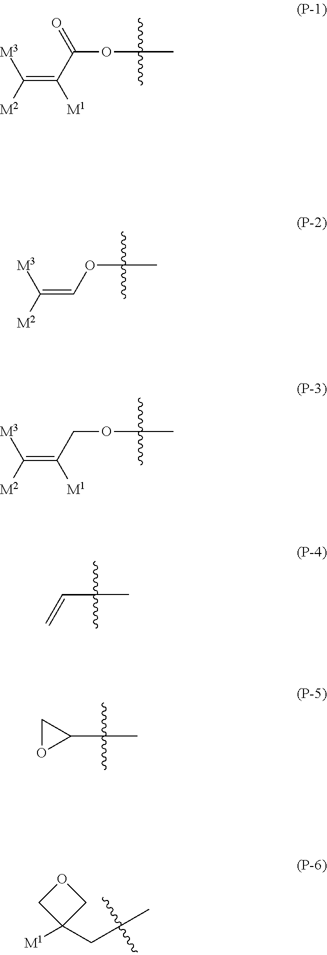

wherein, in formula (P-1) to formula (P-6), M¹, M² and M³ are independently hydrogen, fluorine, alkyl having 1 to 5 carbons, or alkyl having 1 to 5 carbons in which at least one of hydrogen is replaced by halogen;
in formula (6), when all of g pieces of P¹ and i pieces of P³ are a group represented by formula (P-4), at least one of g pieces of Sp¹ and i pieces of Sp³ is alkylene in which at least one of —CH₂— is replaced by —O—, —COO—, —OCO— or —OCOO—.

Item 13. The liquid crystal composition according to any one of items 1 to 12, containing least one polymerizable compound selected from the group consisting of compounds represented by formula (6-1) to formula (6-27) as the additive component:

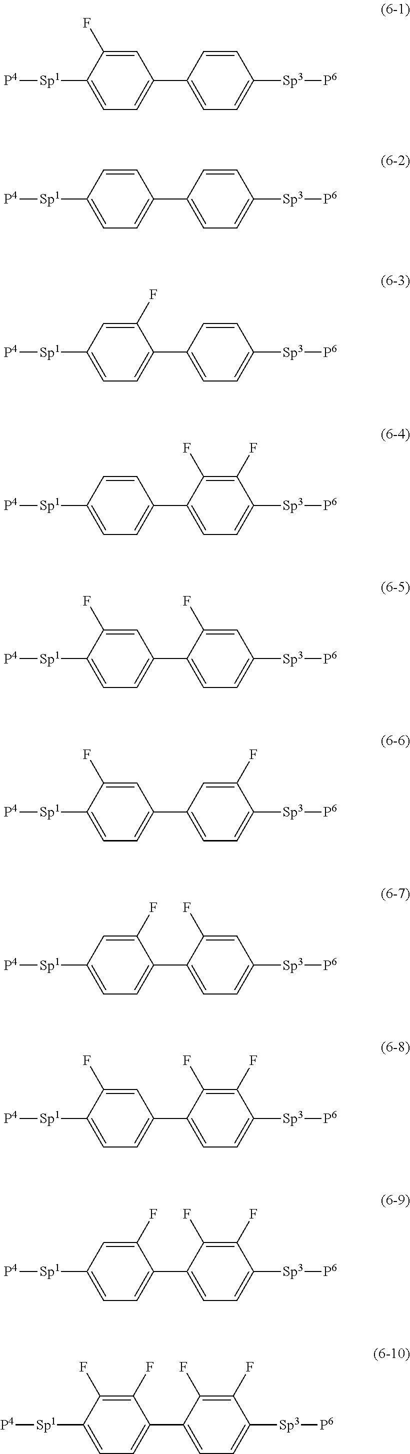

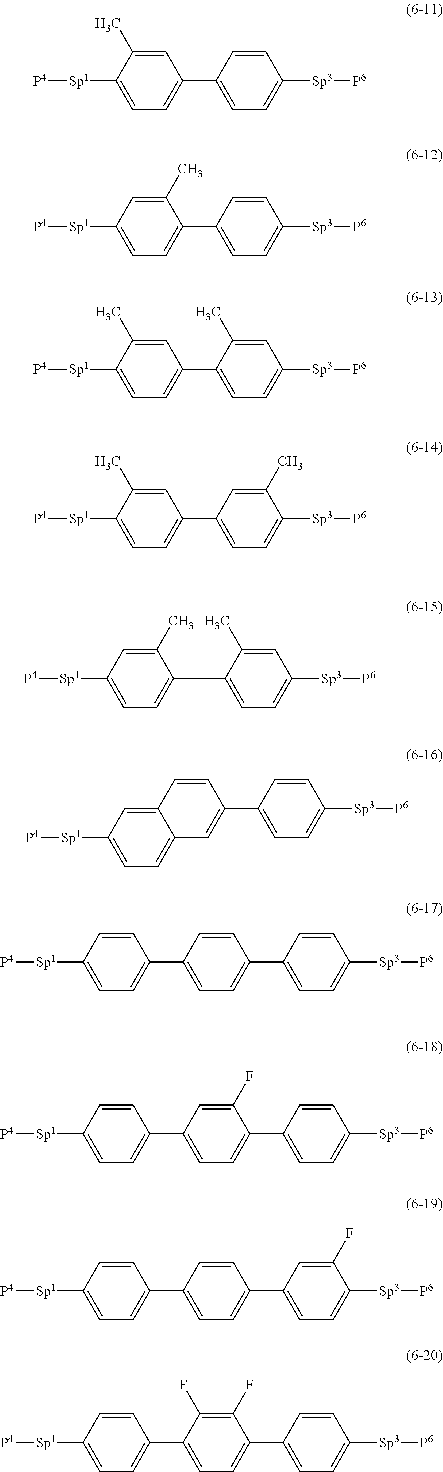

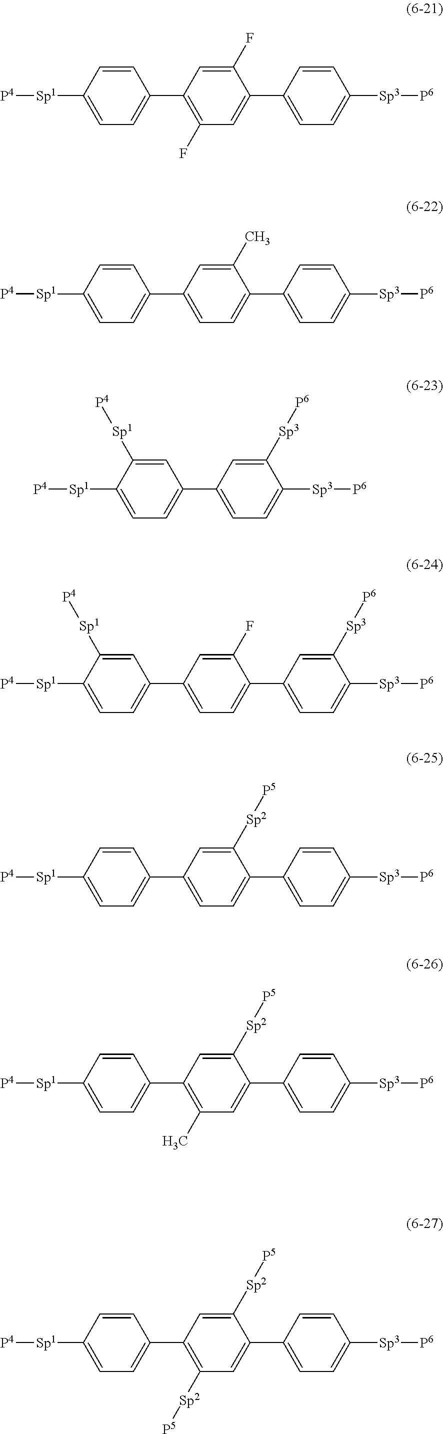

wherein, in formula (6-1) to formula (6-27), P⁴, P⁵ and P⁶ are independently a polymerizable group selected from the group consisting of groups represented by formula (P-1) to formula (P-3):

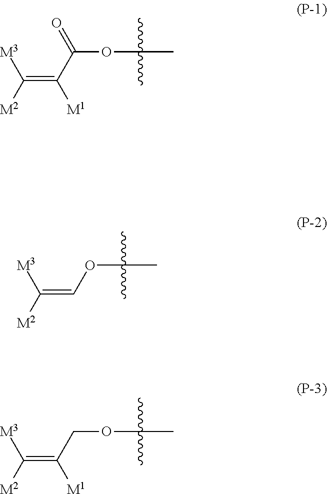

wherein, in formula (P-1) to formula (P-3), M₁, M₂ and M₃ are independently hydrogen, fluorine, alkyl having 1 to 5 carbons, or alkyl having 1 to 5 carbons in which at least one of hydrogen is replaced by halogen; Sp¹, Sp² and Sp³ are independently a single bond or alkylene having 1 to 10 carbons, and in the alkylene, at least one of —CH₂— may be replaced by —O—, —COO—, —OCO— or —OCOO—, at least one of —CH₂—CH₂— may be replaced by —CH═CH— or —C≡C—, and in the groups, at least one of hydrogen may be replaced by fluorine or chlorine.

Item 14. The liquid crystal composition according to any one of items 11 to 13, wherein a ratio of the additive component is in the range of 0.03% by weight to 10% by weight based on the weight of the liquid crystal composition.

Item 15. A liquid crystal display device, including the liquid crystal composition according to any one of items 1 to 14.

Item 16. The liquid crystal display device according to item 15, wherein an operating mode in the liquid crystal display device includes an IPS mode, a VA mode, an FFS mode or an FPA mode, and a driving mode in the liquid crystal display device includes an active matrix mode.

Item 17. A liquid crystal display device having a polymer sustained alignment mode, wherein the liquid crystal display device includes the liquid crystal composition according to any one of items 11 to 14, or a polymerizable compound in the liquid crystal composition is polymerized.

Item 18. Use of the liquid crystal composition according to any one of items 1 to 14 in a liquid crystal display device.

Item 19. Use of the liquid crystal composition according to any one of items 1 to 14 in a liquid crystal display device having a polymer sustained alignment mode.

The invention further includes the following items: (a) the composition containing at least one compound selected from compound (5) to compound (7) having a positive dielectric anisotropy as described in JP 2006-199941 A; (b) the composition containing polymerizable compound (6); (c) the composition containing a polymerizable compound different from polymerizable compound (6); (d) the composition containing at least one additive such as an optically active compound, an antioxidant, an ultraviolet light absorber, a dye, an antifoaming agent, a polymerization initiator and a polymerization inhibitor; (e) an AM device including the composition; (f) a device including the composition and having a TN mode, an ECB mode, an OCB mode, an IPS mode, an FFS mode, a VA mode or an FPA mode; (g) a transmissive device including the composition; (h) use of the composition as a composition having a nematic phase; and (i) use of an optically active composition by adding the optically active compound to the composition.

The composition of the invention will be described in the following order. First, a constitution of component compounds in the composition will be described. Second, main characteristics of the component compounds and main effects of the compounds on the composition are described. Third, a combination of components in the composition, a preferred ratio of the components and a basis thereof are described. Fourth, a preferred embodiment of the component compounds will be described. Fifth, specific examples of the component compounds are shown. Sixth, an additive may be mixed with the composition will be described. Seventh, methods for synthesizing the component compounds are described. Last, an application of the composition will be described.

First, the constitution of the component compounds in the composition will be described. The composition of the invention is classified into composition A and composition B. Composition A may further contain any other liquid crystal compound, any other additive or the like in addition to the liquid crystal compound selected from compound (1), compound (2), compound (3), compound (4) and compound (5), and compound (6). “Any other liquid crystal compound” means a liquid crystal compound different from compound (1), compound (2), compound (3), compound (4), compound (5) and compound (6). Such a compound is mixed with the composition for the purpose of further adjusting the characteristics. Of other liquid crystal compounds, a ratio of a cyano compound is preferably as small as possible in view of stability to heat or ultraviolet light. A further preferred ratio of the cyano compound is 0% by weight. The additive is the optically active compound, the antioxidant, the ultraviolet light absorber, the dye, the antifoaming agent, the polymerizable compound, the polymerization initiator, the polymerization inhibitor or the like.

Composition B essentially consists of compounds selected from compound (1), compound (2), compound (3), compound (4) compound (5) and compound (6). An expression “essentially” means that the composition may contain any other additive, but does not contain any other compound different from compound (1), compound (2), compound (3), compound (4), compound (5) and compound (6). Composition B has a smaller number of components than composition A has. Composition B is preferred to composition A in view of cost reduction. Composition A is preferred to composition B in view of possibility of further adjusting physical properties by mixing with any other liquid crystal compound.

Second, the main characteristics of the component compounds and the main effects of the compounds on the characteristics of the composition are described. The main characteristics of the component compounds are summarized in Table 2 on a basis of advantageous effects of the invention. In Table 2, a symbol L stands for “large” or “high,” a symbol M stands for “medium” and a symbol S stands for “small” or “low.” The symbols L, M and S represent a classification based on a qualitative comparison among the component compounds, and 0 (zero) means “a value is nearly zero.”

TABLE 2
Characteristics of Compounds

| | Compounds | | | | |
|---|---|---|---|---|---|
| | (1) | (2) | (3) | (4) | (5) |
| Maximum temperature | M | S to L | S to L | S to L | S to L |
| Viscosity | S | M to L | M to L | S to L | M to L |
| Optical anisotropy | S | M to L | M to L | S to L | M to L |
| Dielectric anisotropy | 0 | M to L¹⁾ | M to L¹⁾ | 0 | M to L¹⁾ |
| Specific resistance | L | L | L | L | L |

¹⁾A value of dielectric anisotropy is negative, and the symbol shows magnitude of an absolute value.

Upon mixing the component compounds with the composition, the main effects of the component compounds on the characteristics of the composition are as described below. Compound (1) decreases the viscosity. Compound (2) increases the dielectric anisotropy. Compound (3) increases optical anisotropy or increases the dielectric anisotropy. Compound (4) decreases the viscosity or increases the maximum temperature. Compound (5) increases the dielectric anisotropy and decreases the minimum temperature. Compound (6) gives the polymer by polymerization, and the polymer shortens a response time in the device, and improves image persistence.

Third, the combination of components in the composition, the preferred ratio of the components and the basis thereof are described. The combination of components in the composition includes a combination of the first component, the second component and the third component, a combination of the first component, the second component, the third component and the fourth component, a combination of the first component, the second component, the third component and the fifth component, a combination of the first component, the second component, the third component and the additive component, a combination of the first component, the second component, the third component, the fourth component and the fifth component, a combination of the first component, the second component, the third component, the fourth component and the additive component, a combination of the first component, the second component, the third component, the fifth component and the additive component, and a combination of the first component, the second component, the third component, the fourth component, the fifth component and the additive component. A preferred combination of components is the combination of the first component, the second component, the third component, the fourth component and the fifth component, or the combination of the first component, the second component, the third component, the fourth component, the fifth component and the additive component. Here, the additive component means polymerizable compound (6)

A preferred ratio of the first component is approximately 3% by weight or more for decreasing the viscosity, and approximately 30% by weight or less for increasing an absolute value of dielectric anisotropy, based on the weight of the liquid crystal composition. A further preferred ratio is in the range of approximately 3% by weight to approximately 25% by weight based thereon. A particularly preferred ratio is in the range of approximately 3% by the weight to approximately 20% of the weight based thereon.

A preferred ratio of the second component is approximately 5% by weight or more for increasing the absolute value of dielectric anisotropy, and approximately 50% by weight or less for decreasing the minimum temperature, based on the weight of the liquid crystal composition. A further preferred ratio is in the range of approximately 5% by weight to approximately 45% by weight based thereon. A particularly preferred ratio is in the range of approximately 10% by weight to approximately 40% by weight based thereon.

A preferred ratio of the third component is approximately 3% by weight or more for increasing the absolute value of dielectric anisotropy, and approximately 50% by weight or less for decreasing the minimum temperature based on the weight of the liquid crystal composition. A further preferred ratio is in the range of approximately 3% by weight to approximately 45% by weight based thereon. A particularly preferred ratio is in the range of approximately 5% by weight to approximately 40% by weight based thereon.

A preferred ratio of the fourth component is approximately 5% by weight or more for increasing the maximum temperature or decreasing the viscosity, and approximately 80% by weight or less for increasing the absolute value of dielectric anisotropy, based on the weight of the liquid crystal composition. A further preferred ratio is in the range of approximately 10% by weight to approximately 70% by weight based thereon. A particularly preferred ratio is in the range of approximately 10% by weight to approximately 60% by weight based thereon.

A preferred ratio of the fifth component is approximately 3% by weight or more for increasing the dielectric anisotropy, and approximately 50% by weight or less for decreasing the viscosity, based on the weight of the liquid crystal composition. A further preferred ratio is in the range of approximately 3% by weight to less from approximately 45% by weight based thereon. A particularly preferred ratio is in the range of approximately 5% by weight to approximately 40% by weight based thereon.

Compound (6) is mixed with the composition to be adapted for the device having the polymer sustained alignment mode. A preferred ratio of the additive is approximately 0.03% by weight or more for aligning liquid crystal molecules, and approximately 10% by weight or less for preventing a poor display in the device, based on the weight of the liquid crystal composition. A further preferred additive ratio is in the range of approximately 0.1% by weight to approximately 2% by weight based thereon. A particularly preferred additive ratio is in the range of approximately 0.2% by weight to approximately 1.0% by weight based thereon.

The characteristics of the composition described to Table 1 can be adjusted by adjusting the ratio of the component compounds. The characteristics of the composition may be adjusted by mixing any other liquid crystal compound when necessary. A composition having a maximum temperature of approximately 70° C. or higher can be prepared by such a method. A composition having a maximum temperature of approximately 75° C. or higher can also be prepared. A composition having a maximum temperature of approximately 80° C. higher can also be prepared. A composition having a minimum temperature of approximately −10° C. or lower can also be prepared by such a method. A composition having a minimum temperature of approximately −20° C. or lower can also be prepared. A composition having a minimum temperature of approximately −30° C. or lower can also be prepared.

A composition having an optical anisotropy (measured at 25° C.) at a wavelength of 589 nanometers in the range of approximately 0.09 to approximately 0.12 can also be prepared by such a method. A composition having an optical anisotropy in the range of approximately 0.08 to approximately 0.16 can also be prepared. A composition having an optical anisotropy in the range of approximately 0.07 to approximately 0.20 can also be prepared. A composition having a dielectric anisotropy (measured at 25° C.) of approximately −1.5 or less at a frequency of 1 kHz can also be prepared by such a method. A composition having a dielectric anisotropy of approximately −2 or less can also be prepared. A composition having a dielectric anisotropy of approximately −2.5 or less can also be prepared.

Fourth, the preferred embodiment of the component compounds will be described. In compound (1) to compound (5), R¹, R², R³, R⁴, R⁵, R⁶, R⁹ and R¹⁶ are independently alkyl having 1 to 12 carbons, alkoxy having 1 to 12 carbons, alkenyl having 2 to 12 carbons or alkenyloxy having 2 to 12 carbons. Preferred R¹, R², R³, R⁴, R⁵, R⁶, R⁹ or R¹⁰ is alkyl having 1 to 12 carbons for increasing the stability, and alkoxy having 1 to 12 carbons for increasing the dielectric anisotropy. R⁷ and R⁸ are independently alkyl having 1 to 12 carbons, alkoxy having 1 to 12 carbons, alkenyl having 2 to 12 carbons, alkyl having 1 to 12 carbons in which at least one of hydrogen is replaced by fluorine, or alkenyl having 2 to 12 carbons in which at least one of hydrogen is replaced by fluorine. Preferred R⁷ or R⁹ is alkenyl having 2 to 12 carbons for decreasing the viscosity, or alkyl having 1 to 12 carbons for increasing the stability.

Preferred alkyl is methyl, ethyl, propyl, butyl, pentyl, hexyl, heptyl or octyl. Further preferred alkyl is ethyl, propyl, butyl, pentyl or heptyl for decreasing the viscosity.

Preferred alkoxy is methoxy, ethoxy, propoxy, butoxy, pentyloxy, hexyloxy or heptyloxy. Further preferred alkoxy is methoxy or ethoxy for decreasing the viscosity.

Preferred alkenyl is vinyl, 1-propenyl, 2-propenyl, 1-butenyl, 2-butenyl, 3-butenyl, 1-pentenyl, 2-pentenyl, 3-pentenyl, 4-pentenyl 1-hexenyl, 2-hexenyl, 3-hexenyl, 4-hexenyl or 5-hexenyl. Further preferred alkenyl is vinyl, 1-propenyl, 3-butenyl or 3-pentenyl for decreasing the viscosity. A preferred configuration of —CH═CH— in alkenyl depends on a position of a double bond. Trans is preferred in alkenyl such as 1-propenyl, 1-butenyl, 1-pentenyl, 1-hexenyl, 3-pentenyl and 3-hexenyl for decreasing the viscosity and so forth. Cis is preferred in alkenyl such as 2-butenyl, 2-pentenyl and 2-hexenyl. In the alkenyl, straight-chain alkenyl is preferred to branched-chain alkenyl.

Preferred alkenyloxy is vinyloxy, allyloxy, 3-butenyloxy, 3-pentenyloxy or 4-pentenyloxy. Further preferred alkenyloxy is allyloxy or 3-butenyloxy for decreasing the viscosity.

A preferred example of alkenyl in which at least one of hydrogen is replaced by fluorine is 2,2-difluorovinyl, 3,3-difluoro-2-propenyl, 4,4-difluoro-3-butenyl, 5,5-difluoro-4-pentenyl or 6,6-difluoro-5-hexenyl. A further preferred example is 2,2-difluorovinyl or 4,4-difluoro-3-butenyl for decreasing the viscosity.

Alkyl has a straight or branched chain, and contains no cyclic alkyl. Straight-chain alkyl is preferred to branched-chain alkyl. A same rule is also applied to alkoxy, alkenyl, and alkenyl in which at least one of hydrogen is replaced by fluorine. According to a configuration of 1,4-cyclohexylene, trans is preferred to cis for increasing the maximum temperature.

Ring A and ring B are independently 1,4-cyclohexylene, 1,4-phenylene or tetrahydropyran-2,5-diyl. Preferred ring A or ring B is 1,4-cyclohexylene for decreasing the viscosity, tetrahydropyran-2,5-diyl for increasing the dielectric anisotropy, and 1,4-phenylene for increasing the optical anisotropy. According to the configuration of 1,4-cyclohexylene, trans is preferred to cis for increasing the maximum temperature. Tetrahydropyran-2,5-diyl is:

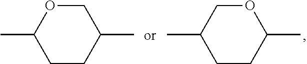

and preferably,

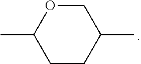

Ring C and ring D are independently 1,4-cyclohexylene, 1,4-phenylene, 2-fluoro-1,4-phenylene or 2,5-difluoro-1,4-phenylene. Preferred ring C or ring D is 1,4-cyclohexylene for decreasing the viscosity or for increasing the maximum temperature, and 1,4-phenylene for increasing the optical anisotropy. According to the configuration of 1,4-cyclohexylene, trans is preferred to cis for increasing the maximum temperature.

Ring E is 1,4-cyclohexylene, 1,4-cyclohexenylene or tetrahydropyran-2,5-diyl. Preferred ring E is 1,4-cyclohexylene for decreasing the viscosity, and tetrahydropyran-2,5-diyl for increasing the dielectric anisotropy. According to the configuration of 1,4-cyclohexylene, trans is preferable to cis for increasing the maximum temperature. Tetrahydropyran-2,5-diy is:

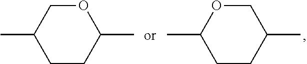

and preferably,

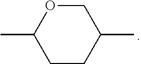

Ring F is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl, or 7,8-difluorochroman-2,6-diyl. A preferred ring F is 2,3-difluoro-1,4-phenylene for decreasing the viscosity, 2-chloro-3-fluoro-1,4-phenylene for decreasing the optical anisotropy, and 7,8-difluorochroman-2,6-diyl for increasing the dielectric anisotropy.

X¹ and X² are independently hydrogen, fluorine or chlorine. Preferred X¹ or X² is hydrogen for decreasing the viscosity. X³ and X⁴ are independently fluorine or chlorine. Preferred X³ or X⁴ is fluorine for increasing the dielectric anisotropy.

Z¹, Z², and Z³ are independently a single bond, —CH₂CH₂—, —CH₂O—, —OCH₂—, —COO— or —OCO—. Preferred Z¹ or Z³ is a single bond for decreasing the viscosity, —CH₂CH₂— for decreasing the minimum temperature, and —CH₂O— or —OCH₂— for increasing the dielectric anisotropy. Preferred Z² is a single bond for decreasing the viscosity.

Then, a and c are independently 0 or 1; b is 0, 1, or 2; and a sum of b and c is 0, 1 or 2. Preferred b is 0 for decreasing the viscosity, and 1 or 2 for increasing the maximum temperature. Preferred c is 0 for decreasing the viscosity. Then, d is 1, 2 or 3. Preferred d is 1 for decreasing the viscosity, and 2 or 3 for increasing the maximum temperature. Then, e is 1, 2 or 3. Preferred e is 1 for decreasing the viscosity, and 2 or 3 for increasing the maximum temperature.

In formula (6), P¹, P² and P³ are a polymerizable group. Preferred P¹, P² or P³ is a polymerizable group selected from the group consisting of groups represented by formula (P-1) to formula (P-6). Further preferred P¹, P² or P³ is group (P-1) or group (P-2). Particularly preferred group (P-1) is —OCO—CH═CH₂ or —OCO—C(CH₃)═CH₂. A wavy line in group (P-1) to group (P-6) represents a part to be bonded.

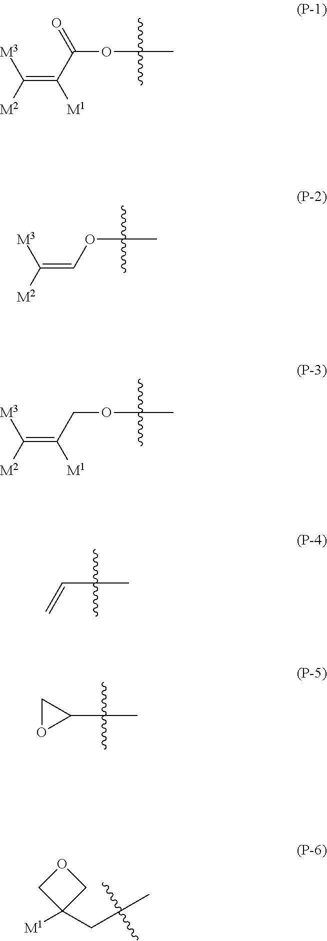

In group (P-1) to group (P-6), M¹, M² and M³ are independently hydrogen, fluorine, alkyl having 1 to 5 carbons, or alkyl having 1 to 5 carbons in which at least one of hydrogen is replaced by halogen. Preferred M¹, M² or M³ is hydrogen or methyl for increasing reactivity. Further preferred M¹ is methyl, and further preferred M² or M³ is hydrogen. When at least two of g pieces of P¹, h pieces of P², and i pieces of P³ are group (P-1), two of arbitrary M¹, M² or M³ in P¹, P² and P³ may be identical or different. A same rule is also applied to group (P-2) or group (P-3).

When all of g pieces of P¹ and i pieces of P³ are group (P-4), at least one of g pieces of Sp¹ and h pieces of Sp³ is alkylene in which at least one of —CH₂— is replaced by —O—, —COO—, —OCO— or —OCOO—. More specifically, a case where all of g pieces of P¹ and i pieces of P³ are alkenyl such as 1-propenyl is excluded.

In formula (6-1) to formula (6-27), P⁴, P⁵ and P⁶ are independently a group represented by formula (P-1) to formula (P-3). Preferred P⁴, P⁵ or P⁶ is group (P-1) or group (P-2). Further preferred group (P-1) is —OCO—CH═CH₂ or —OCO—C(CH₃)═CH₂. A wavy line in group (P-1) to group (P-3) represents a part to be bonded.

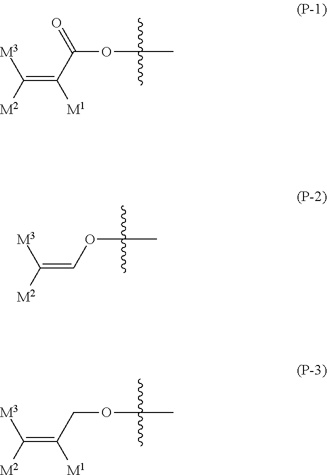

When at least two of one or two of P⁴, one or two of P⁵, and one or two of P⁶ are group (P-1), two of arbitrary M¹, M² or M³ in P⁴, P⁵ and P⁶ may be identical or different. A same rule is also applied to group (P-2) or group (P-3).

In formula (6), Sp¹, Sp² and Sp³ are independently a single bond or alkylene having 1 to 10 carbons, and in the alkylene, at least one of —CH₂— may be replaced by —O—, —COO—, —OCO— or —OCOO—, at least one of —CH₂—CH₂— may be replaced by —CH═CH— or —C≡C—, and in the groups, at least one of hydrogen may be replaced by fluorine or chlorine. When hydrogen is replaced by —C≡N, a total of number of carbons in cyano-substituted alkylene is preferably 10 or less. Preferred Sp¹, Sp² or Sp³ is a single bond.

Ring G and ring J are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one of hydrogen may be replaced by halogen, alkyl having 1 to 12 carbons, alkoxy having 1 to 12 carbons, or alkyl having 1 to 12 carbons in which at least one of hydrogen is replaced by halogen. Preferred ring G or ring J is phenyl. Ring I is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one of hydrogen may be replaced by halogen, alkyl having 1 to 12 carbons, alkoxy having 1 to 12 carbons, or alkyl having 1 to 12 carbons in which at least one of hydrogen is replaced by halogen. Particularly preferred ring I is 1,4-phenylene or 2-fluoro-1,4-phenylene.

Z⁴ and Z⁵ are independently a single bond or alkylene having 1 to 10 carbons, and in the alkylene, at least one of —CH₂— may be replaced by —O—, —CO—, —COO— or —OCO—, at least one of —CH₂—CH₂— may be replaced by CH═CH—, —C(CH₃)═CH—, —CH═C(CH₃)— or —C(CH₃)═C(CH₃)—, and in the groups, at least one of hydrogen may be replaced by fluorine or chlorine. Preferred Z⁴ or Z⁵ is a single bond, —CH₂CH₂—, —CH₂O—, —OCH₂—, —COO— or —OCO—. Further preferred Z⁴ or Z⁵ is a single bond.

Then, f is 0, 1 or 2. Preferred f is 0 or 1. Then, g, h and i are independently 0, 1, 2, 3 or 4, and a sum of g, hand i is 1 or more. Preferred g, h, or i is 1 or 2.

Fifth, the preferred component compound will be described. Preferred compound (1) includes compound (1) described above.

Preferred compound (2) includes compound (2-1) and compound (2-2) described in item 2. In the compounds, at least one second component preferably includes compound (2-1) or compound (2-2). At least two second components preferably include a combination of compound (2-1) and compound (2-2).

Preferred compound (3) includes compound (3-1) to compound (3-7) described in item 3. In the compounds, at least one third component preferably includes compound (3-1) or compound (3-4). At least two third components preferably include a combination of compound (3-1) and compound (3-4).

Preferred compound (4) includes compound (4-1) to compound (4-13) described in item 6. In the compounds, at least one fourth component preferably includes compound (4-1), compound (4-3), compound (4-5), compound (4-6), compound (4-7) or compound (4-8). At least two fourth components preferably include a combination of compound (4-1) and compound (4-3), a combination of compound (4-1) and compound (4-5), or a combination of compound (4-1) and compound (4-6).

Preferred compound (5) includes compound (5-1) to compound (5-9) described in item 9. In the compounds, at least one fifth component preferably includes compound (5-1) or compound (5-3). At least two fifth components preferably include a combination of compound (5-1) and compound (5-3).

Preferred compound (6) includes compound (6-1) to compound (6-27) described in item 13. In the compounds, at least one additive component preferably includes compound (6-1), compound (6-2), compound (6-24), compound (6-25), compound (6-26) or compound (6-27). At least two additive components preferably include a combination of compound (6-1) and compound (6-2), a combination of compound (6-1) and compound (6-18), a combination of compound (6-2) and compound (6-24), a combination of compound (6-2) and compound (6-25), a combination of compound (6-2) and compound (6-26), a combination of compound (6-25) and compound (6-26) or a combination of compound (6-18) and compound (6-24). In group (P-1) to group (P-3), preferred M¹, M² or M³ is hydrogen or methyl. Preferred Sp¹, Sp² or Sp³ is a single bond, —CH₂CH₂—, —CH₂O—, —OCH₂—, —COO—, —OCO—, —CO—CH═CH— or —CH═CH—CO—.

Sixth, the additive that may be added to the composition will be described. The additive is the optically active compound, the antioxidant, the ultraviolet light absorber, the dye, the antifoaming agent, the polymerizable compound, the polymerization initiator, the polymerization inhibitor and so forth. The optically active compound is mixed with the composition for inducing a helical structure in a liquid crystal to give a twist angle. Examples of such a compound are compound (7-1) to compound (7-5). A preferred ratio of the optically active compound is approximately 5% by weight or less. A further preferred ratio is in the range of approximately 0.01% by weight to approximately 2% by weight.

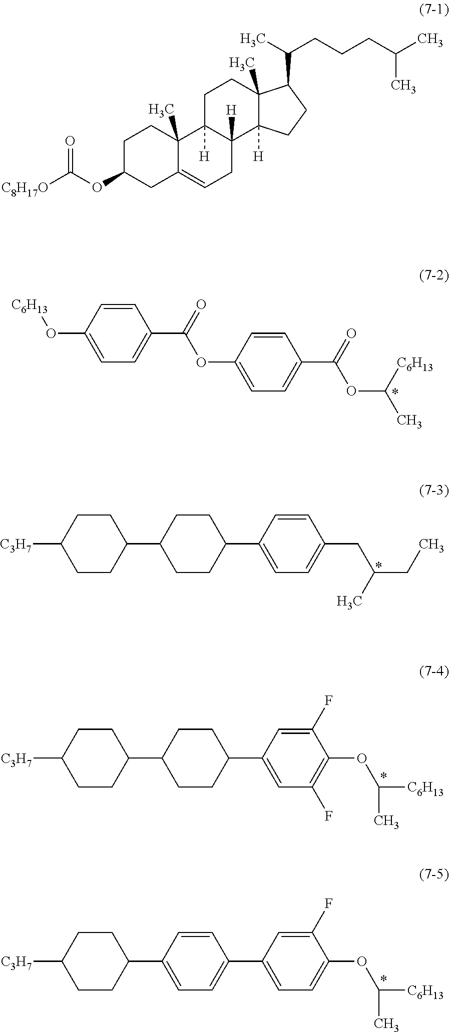

The antioxidant is mixed with the composition for preventing a decrease in the specific resistance caused by being heated in air, or for maintaining the large voltage holding ratio at room temperature and also at the temperature close to the maximum temperature of the nematic phase after the device has been used for a long period of time.

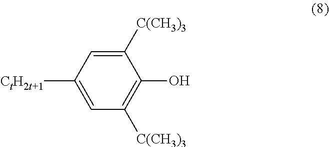

A preferred example of the antioxidant includes compound (8) where t is an integer from 1 to 9. Preferred t in compound (8) is 1, 3, 5, 7 or 9. Further preferred t is 7. Compound (8) where t is 7 is effective for maintaining the large voltage holding ratio at room temperature and also at the temperature close to the maximum temperature of the nematic phase after the device has been used for a long period of time because the above compound (8) has a small volatility. A preferred ratio of the antioxidant is approximately 50 ppm or more for achieving an effect thereof, and approximately 600 ppm or less for avoiding a decrease in the maximum temperature or an increase in the minimum temperature. A further preferred ratio is in the range of approximately 100 ppm to approximately 300 ppm.

A preferred example of the ultraviolet light absorber includes a benzophenone derivative, a benzoate derivative and a triazole derivative. A light stabilizer such as an amine having steric hindrance is also preferred. A preferred ratio of the absorber or the stabilizer is approximately 50 ppm or more for achieving an effect thereof, and approximately 10,000 ppm or less for avoiding a decrease in the maximum temperature or avoiding an increase in the minimum temperature. A further preferred ratio is in the range of approximately 100 ppm to approximately 10,000 ppm.

A dichroic dye such as an azo dye or an anthraquinone dye is mixed with the composition to be adapted to a device having a guest host (GH) mode. A preferred ratio of the dye is in the range of approximately 0.01% by weight to approximately 10% by weight. The antifoaming agent such as dimethyl silicone oil or methyl phenyl silicone oil is mixed with the composition for preventing foam formation. A preferred ratio of the antifoaming agent is approximately 1 ppm or more for achieving an effect thereof, and approximately 1,000 ppm or less for avoiding a poor display. A further preferred ratio is in the range of approximately 1 ppm to approximately 500 ppm.

The polymerizable compound is used to be adapted to a device having a polymer sustained alignment (PSA) mode. Compound (6) is suitable for the purpose. A polymerizable compound different from compound (6) may be mixed with the composition together with compound (6). A preferred example of such a polymerizable compound includes a compound such as acrylate, methacrylate, a vinyl compound, a vinyloxy compound, propenyl ether, an epoxy compound (oxirane, oxetane) and vinyl ketone. A further preferred example includes an acrylate derivative or a methacrylate derivative. A preferred ratio of compound (6) is approximately 10% by weight or more based on the total weight of the polymerizable compound. A further preferred ratio is 50% by weight or more. A particularly preferred ratio is 80% by weight or more. A particularly preferred ratio is also approximately 100% by weight.

The polymerizable compound such as compound (6) is polymerized by irradiation with ultraviolet light. The polymerizable compound such as compound (6) may be polymerized in the presence of a suitable initiator such as a photopolymerization initiator. Suitable conditions for polymerization, suitable types of the initiator and suitable amounts thereof are known to those skilled in the art and are described in literature. For example, Irgacure 651 (registered trademark; BASF), Irgacure 184 (registered trademark; BASF) or Darocur 1173 (registered trademark; BASF), each being a photoinitiator, is suitable for radical polymerization. A preferred ratio of the photopolymerization initiator is in the range of approximately 0.1% by weight to approximately 5% by weight based on the total weight of the polymerizable compound. A further preferred ratio is in the range of approximately 1% by weight to approximately 3% by weight.

Upon keeping the polymerizable compound such as compound (6), the polymerization inhibitor may be added thereto. The polymerizable compound is ordinarily added to the composition without removing the polymerization inhibitor. An example of the polymerization inhibitor includes hydroquinone and a hydroquinone derivative such as methylhydroquinone, 4-tert-butylcatechol, 4-methoxyphenol and phenothiazine.

Seventh, the methods for synthesizing the component compounds are described. The compounds are synthesized by a known method. Examples of synthetic methods are described.

Compound (1) is synthesized by a method described in JP S61-215336 A. Compound (2-1) and compound (2-2) are synthesized by a method described in JP H2-503568 A. Compound (3-4) is synthesized by a method described in JP S57-114532 A. Compound (4-2) is synthesized by a method described in JP S54-002283 A or JP S56-68636 A. Compound (5-1), compound (5-2) and compound (5-3) are synthesized by a method described in JP H2-503441 A or JP 2000-053602 A. Compound (6) is synthesized with reference to JP 2012-001526 A or WO 2010/131600 A. Compound (6-18) is synthesized by a method described in JP H7-101900 A. The antioxidant is commercially available. A compound where t in formula (8) is 1 can be obtained from Sigma-Aldrich Corporation. A compounds where t in compound (8) is 7 can be synthesized according to a method described to U.S. Pat. No. 3,660,505 B.

Any compounds whose synthetic methods are not described can be prepared according to methods described in books such as Organic Syntheses (John Wiley & Sons, Inc.), Organic Reactions (John Wiley & Sons, Inc.), Comprehensive Organic Synthesis (Pergamon Press) and New Experimental Chemistry Course (Shin Jikken Kagaku Koza in Japanese) (Maruzen Co., Ltd.). The composition is prepared according to publicly known methods using the thus obtained compounds. For example, the component compounds are mixed and dissolved in each other by heating.

Last, the application of the composition will be described. The composition of the invention mainly has a minimum temperature of approximately −10° C. or lower, a maximum temperature of approximately 70° C. or higher, and an optical anisotropy in the range of approximately 0.07 to approximately 0.20. A device including the composition has a large voltage holding ratio. The composition is suitable for use in the AM device. The composition is particularly suitable for use in a transmissive AM device. A composition having an optical anisotropy in the range of approximately 0.08 to approximately 0.25, and also a composition having an optical anisotropy in the range of approximately 0.10 to approximately 0.30 may be prepared by controlling a ratio of the component compounds or by mixing with any other liquid crystal compound. The composition can be used as the composition having the nematic phase, and as the optically active composition by adding the optically active compound.

The composition can be used for the AM device. The composition can also be used to a PM device. The composition can also be used for an AM device and a PM device each having a mode such as a PC mode, a TN mode, an STN mode, an ECB mode, an OCB mode, an IPS mode, a VA mode and an FPA mode. Use for the AM device having the TN mode, the OCB mode, the IPS mode or the FFS mode is particularly preferred. When no voltage is applied, alignment of liquid crystal molecules may be parallel or perpendicular to a glass substrate in the AM device having the IPS mode or the FFS mode. The device may be of a reflective type, a transmissive type or a transreflective type. Use for the transmissive device is preferred. Use for an amorphous silicon-TFT device or a polycrystal silicon-TFT device is allowed. Use for a nematic curvilinear aligned phase (NCAP) device prepared by microencapsulating the composition, or for a polymer dispersed (PD) device in which a three-dimensional network-polymer is formed in the composition is allowed.

One example of the method for manufacturing the device having the polymer sustained alignment mode is as described below. A device having two substrates referred to as an array substrate and a color filter substrate is prepared. At least one of the substrates has an electrode layer. The liquid crystal composition is prepared by mixing the liquid crystal compounds. The polymerizable compound is added to the composition. The additive may be further added when necessary. The composition is injected into the device. The device is irradiated with light in a state in which voltage is applied. Irradiation with ultraviolet light is preferred. The polymerizable compound is polymerized by irradiation with light. The composition containing the polymer is formed by the polymerization. The liquid crystal display device having the polymer sustained alignment mode is manufactured according to such a procedure.

In the procedure, when voltage is applied, the liquid crystal molecules are aligned due to an effect of an electric field. Molecules of the polymerizable compound are also aligned according to the alignment. The polymerizable compound is polymerized by irradiation with ultraviolet light in the above state, and therefore a polymer in which the alignment is maintained is formed. The response time in the device is shortened due to an effect of the polymer. The image persistence is caused due to a poor operation in the liquid crystal molecules, and therefore is to be simultaneously improved by the effect of the polymer. In addition, the polymerizable compound in the composition is previously polymerized, and the composition may be arranged between the substrates in the liquid crystal display device.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

The following examples are for illustrative purposes only and are not intended, nor should they be interpreted to, limit the scope of the invention.

### EXAMPLES

The invention will be described in greater detail by way of Examples. However, the invention is not limited by the Examples. The invention includes a mixture of a composition in Example 1 and a composition in Example 2. The invention also includes a mixture in which at least two compositions in Examples are mixed. Characteristics of the compound and the composition were measured by methods described below.

Gas chromatographic analysis: GC-14B Gas Chromatograph made by Shimadzu Corporation was used for measurement. A carrier gas was helium (2 mL per minute). A sample injector and a detector (FID) were set to 280° C. and 300° C., respectively. A capillary column DB-1 (length 30 m, bore 0.32 mm, film thickness 0.25 μm; dimethylpolysiloxane as a stationary phase, non-polar) made by Agilent Technologies, Inc. was used for separation of component compounds. After the column was kept at 200° C. for 2 minutes, the column was heated to 280° C. at a rate of 5° C. per minute. A sample was prepared in an acetone solution (0.1% by weight), and then 1 microliter of the solution was injected into the sample injector. A recorder was C-R5A Chromatopac made by Shimadzu Corporation or the equivalent thereof. The resulting gas chromatogram showed a retention time of a peak and a peak area corresponding to each of the component compounds.

As a solvent for diluting the sample, chloroform, hexane and so forth may also be used. The following capillary columns may also be used for separating component compounds: HP-1 (length 30 m, bore 0.32 mm, film thickness 0.25 μm) made by Agilent Technologies, Inc., Rtx-1 (length 30 m, bore 0.32 mm, film thickness 0.25 μm) made by Restek Corporation and BP-1 (length 30 m, bore 0.32 mm, film thickness 0.25 μm) made by SGE International Pty. Ltd. A capillary column CBP1-M50-025 (length 50 m, bore 0.25 mm, film thickness 0.25 μm) made by Shimadzu Corporation may also be used for the purpose of avoiding an overlap of peaks of the compounds.

A ratio of liquid crystal compounds contained in the composition may be calculated by the method as described below. The mixture of liquid crystal compounds is detected by gas chromatograph (FID). An area ratio of each peak in the gas chromatogram corresponds to the ratio (weight ratio) of the liquid crystal compound. When the capillary columns described above were used, a correction coefficient of each of the liquid crystal compounds may be regarded as 1 (one). Accordingly, the ratio (% by weight) of the liquid crystal compound is calculated from the area ratio of each peak.

Sample for measurement: When characteristics of a composition was measured, the composition was used as a sample as was. Upon measuring characteristics of a compound, a sample for measurement was prepared by mixing the compound (15% by weight) with a base liquid crystal (85% by weight). Values of characteristics of the compound were calculated, according to an extrapolation method, using values obtained by measurement: (extrapolated value)={(measured value of a sample for measurement)−0.85×(measured value of abase liquid crystal)}/0.15. When a smectic phase (or crystals) precipitates at the ratio thereof at 25° C., a ratio of the compound to the base liquid crystal was changed step by step in the order of (10% by weight:90% by weight), (5% by weight:95% by weight) and (1% by weight:99% by weight). Values of maximum temperature, optical anisotropy, viscosity and dielectric anisotropy with regard to the compound were determined according to the extrapolation method.

The following base liquid crystal was used. A ratio of the component compound was expressed in terms of weight percent (% by weight).

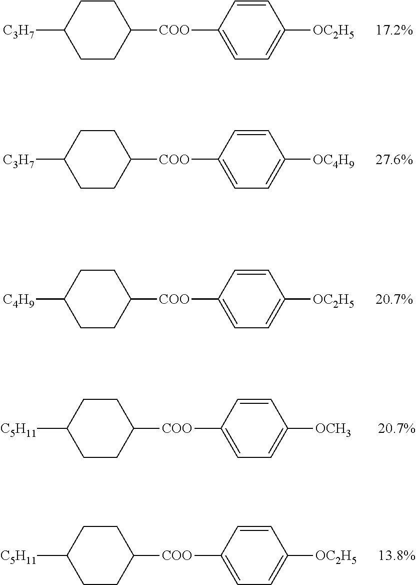

Measuring method: Measurement of characteristics was carried out by the methods described below. Most of the measuring methods are applied as described in the Standard of the Japan Electronics and Information Technology Industries Association (hereinafter abbreviated as JEITA) (JEITA EIAJ ED-2521B) discussed and established by JEITA, or modified thereon. No thin film transistor (TFT) was attached to a TN device used for measurement.

(1) Maximum temperature of a nematic phase (NI; ° C.): A sample was placed on a hot plate in a melting point apparatus equipped with a polarizing microscope and was heated at a rate of 1° C. per minute. Temperature when part of the sample began to change from a nematic phase to an isotropic liquid was measured. A higher limit of a temperature range of the nematic phase may be occasionally abbreviated as “maximum temperature.”

(2) Minimum temperature of a nematic phase (T_{c}; ° C.): Samples each having a nematic phase were put in glass vials and kept in freezers at temperatures of 0° C., −10° C., −20° C., −30° C. and −40° C. for 10 days, and then liquid crystal phases were observed. For example, when the sample maintained the nematic phase at −20° C. and changed to crystals or a smectic phase at −30° C., T_{c} of the sample was expressed as T_{c}<−20° C. A lower limit of a temperature range of the nematic phase may be occasionally abbreviated as “minimum temperature.”

(3) Viscosity (bulk viscosity; η; measured at 20° C.; mPa·s): A cone-plate (E type) rotational viscometer made by Tokyo Keiki, Inc. was used for measurement.

(4) Viscosity (rotational viscosity; γ1; measured at 25° C.; mPa·s): Measurement was carried out according to the method described in M. Imai et al., Molecular Crystals and Liquid Crystals, Vol. 259, p. 37 (1995). A sample was put in a VA device in which a distance (cell gap) between two glass substrates was 20 micrometers. Voltage was applied stepwise to the device in the range of 39 V to 50 V at an increment of 1 V. After a period of 0.2 second with no voltage application, voltage was applied repeatedly under the conditions of only one rectangular wave (rectangular pulse; 0.2 second) and no voltage application (2 seconds). A peak current and a peak time of a transient current generated by the applied voltage were measured. A value of rotational viscosity was obtained from the measured values and a calculation equation (8) described on page 40 of the paper presented by M. Imai et al. The dielectric anisotropy required for the calculation was measured according to section (6) described below.

(5) Optical anisotropy (refractive index anisotropy; Δn; measured at 25° C.): Measurement was carried out by an Abbe refractometer with a polarizing plate mounted on an ocular, using light at a wavelength of 589 nanometers. A surface of a main prism was rubbed in one direction, and then a sample was added dropwise onto the main prism. A refractive index (n∥) was measured when a direction of polarized light was parallel to a direction of rubbing. A refractive index (n⊥) was measured when the direction of polarized light was perpendicular to the direction of rubbing. A value of optical anisotropy was calculated from an equation: Δn=n∥−n⊥.

(6) Dielectric anisotropy (Δ∈; measured at 25° C.): A value of dielectric anisotropy was calculated from an equation: Δ∈=∈∥−∈⊥. A dielectric constant (∈∥ and ∈⊥) was measured as described below.

(1) Measurement of dielectric constant (∈∥): An ethanol (20 mL) solution of octadecyl triethoxysilane (0.16 mL) was applied to a well-cleaned glass substrate. After rotating the glass substrate with a spinner, the glass substrate was heated at 150° C. for 1 hour. A sample was put in a VA device in which a distance (cell gap) between two glass substrates was 4 micrometers, and the device was sealed with an ultraviolet-curable adhesive. Sine waves (0.5 V, 1 kHz) were applied to the device, and after 2 seconds, a dielectric constant (∈∥) in the major axis direction of liquid crystal molecules was measured.

(2) Measurement of dielectric constant (∈⊥): A polyimide solution was applied to a well-cleaned glass substrate. After calcining the glass substrate, rubbing treatment was applied to the alignment film obtained. A sample was put in a TN device in which a distance (cell gap) between two glass substrates was 9 micrometers and a twist angle was 80 degrees. Sine waves (0.5V, 1 kHz) were applied to the device, and after 2 seconds, a dielectric constant (∈⊥) in the minor axis direction of the liquid crystal molecules was measured.

(7) Threshold voltage (Vth; measured at 25° C.; V): An LCD-5100 luminance meter made by Otsuka Electronics Co., Ltd. was used for measurement. A light source was a halogen lamp. A sample was put in a normally black mode VA device in which a distance (cell gap) between two glass substrates was 4 micrometers and a rubbing direction was anti-parallel, and the device was sealed with an ultraviolet-curable adhesive. A voltage (60 Hz, rectangular waves) to be applied to the device was stepwise increased from 0 V to 20 V at an increment of 0.02 V. On the occasion, the device was irradiated with light from a direction perpendicular to the device, and an amount of light transmitted through the device was measured. A voltage-transmittance curve was prepared, in which the maximum amount of light corresponds to 100% transmittance and the minimum amount of light corresponds to 0% transmittance. A threshold voltage is expressed in terms of a voltage at 10% transmittance.

(8) Voltage holding ratio (VHR-1; measured at 25° C.; %): A TN device used for measurement had a polyimide alignment film, and a distance (cell gap) between two glass substrates was 5 micrometers. A sample was put in the device, and the device was sealed with an ultraviolet-curable adhesive. A pulse voltage (60 microseconds at 5 V) was applied to the TN device and the device was charged. A decaying voltage was measured for 16.7 milliseconds with a high-speed voltmeter, and area A between a voltage curve and a horizontal axis in a unit cycle was determined. Area B is an area without decay. A voltage holding ratio is expressed in terms of a percentage of area A to area B.

(9) Voltage holding ratio (VHR-2; measured at 80° C.; %): A TN device used for measurement had a polyimide alignment film, and a distance (cell gap) between two glass substrates was 5 micrometers. A sample was put in the device, and the device was sealed with an ultraviolet-curable adhesive. A pulse voltage (60 microseconds at 5 V) was applied to the TN device and the device was charged. A decaying voltage was measured for 16.7 milliseconds with a high-speed voltmeter, and area A between a voltage curve and a horizontal axis in a unit cycle was determined. Area B is an area without decay. A voltage holding ratio is expressed in terms of a percentage of area A to area B.

(10) Voltage holding ratio (VHR-3; measured at 25° C.; %): Stability to ultraviolet light was evaluated by measuring a voltage holding ratio after a device was irradiated with ultraviolet light. A TN device used for measurement had a polyimide alignment film and a cell gap was 5 micrometers. A sample was injected into the device, and then was irradiated with light for 20 minutes. A light source was an ultra high-pressure mercury lamp USH-500D (made by Ushio, Inc.), and a distance between the device and the light source was 20 centimeters. In measurement of VHR-3, a decaying voltage was measured for 16.7 milliseconds. A composition having large VHR-3 has a large stability to ultraviolet light. A value of VHR-3 is preferably 90% or more, and further preferably, 95% or more.

The compounds described in Comparative Examples and Examples were described using symbols according to definitions in Table 3 below. In Table 3, a configuration of 1,4-cyclohexylene is trans. A parenthesized number next to a symbolized compound in Examples corresponds to the number of the compound. A symbol (-) means any other liquid crystal compound. A ratio (percentage) of the liquid crystal compound is expressed in terms of weight percent (% by weight) based on the weight of the liquid crystal composition. Values of characteristics of the composition were summarized in a last part.

TABLE 3
Method for Description of Compounds using Symbols
R—(A₁)—Z₁— . . . —Zₙ—(Aₙ)—R′

| 1) Left-terminal Group R— | Symbol |
|---|---|
| F—CₙH₂ₙ— | Fn— |
| CₙH₂ₙ₊₁— | n- |
| CₙH₂ₙ₊₁O— | nO— |
| CₘH₂ₘ₊₁OCₙH₂ₙ— | mOn— |
| CH₂═CH— | V— |
| CₙH₂ₙ₊₁—CH═CH— | nV— |
| CH₂═CH—CₙH₂ₙ— | Vn— |
| CₘH₂ₘ₊₁—CH═CH—CₙH₂ₙ— | mVn— |
| CF₂═CH— | VFF— |
| CF₂═CH—CₙH₂ₙ— | VFFn— |
| CH₂═CH—COO— | AC— |
| CH₂═C(CH₃)—COO— | MAC— |
| 2) Right-terminal Group —R′ | Symbol |
| —CₙH₂ₙ₊₁ | -n |
| —OCₙH₂ₙ₊₁ | —On |
| —CH═CH₂ | —V |
| —CH═CH—CₙH₂ₙ₊₁ | —Vn |
| —CₙH₂ₙ—CH═CH₂ | —nV |
| —CₘH₂ₘ—CH═CH—CₙH₂ₙ₊₁ | —mVn |
| —CH═CF₂ | —VFF |
| —OCO—CH═CH₂ | —AC |
| —OCO—C(CH₃)═CH₂ | —MAC |
| 3) Bonding Group —Zₙ— | Symbol |
| —CₙH₂ₙ— | n |
| —COO— | E |
| —CH═CH— | V |
| —CH═CHO— | VO |
| —OCH═CH— | OV |
| —CH₂O— | 1O |
| —OCH₂— | O1 |
| 4) Ring Structure —Aₙ— | Symbol |
| 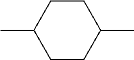 | H |
| 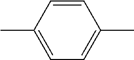 | B |
| 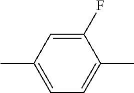 | B(F) |
| 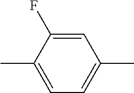 | B(2F) |
| 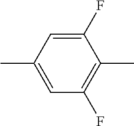 | B(F,F) |
| 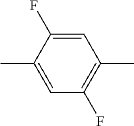 | B(2F,5F) |
| 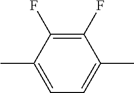 | B(2F,3F) |
| 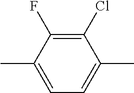 | B(2F,3CL) |
| 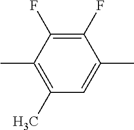 | B(2F,3F,6Me) |
| 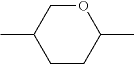 | dh |
| 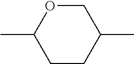 | Dh |
| 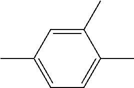 | Bm |
| 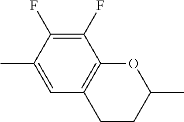 | Cro(7F,8F) |

5) Examples of Description
Example 1 3-HVH-3

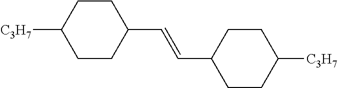

Example 2 2-HH1OB(2F,3F)—O2

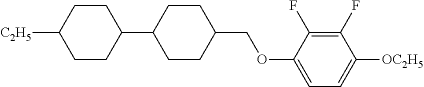 [SMILES: CCOc1ccc(OCC2CCC(C3CCC(CC)CC3)CC2)c(F)c1F]

Example 3 3-BB(2F,3F)—O2

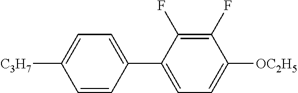

Example 4 3-HBB(2F,3CL)—O2

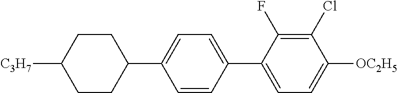

### Comparative Example 1

Example 4 was selected from the liquid crystal compositions disclosed in JP 2011-158820 A. A basis therefor is that the above composition contains a liquid crystal composition containing a compound similar to compound (1) being one of compound (4), compound (2), compound (3), compound (4) and compound (5), and has a negative dielectric anisotropy. Components and characteristics of the composition are as described below.

| | | |
|---|---|---|
| 1V2-HHB-1 | (4-5) | 7% |
| 1V2-HHB-3 | (4-5) | 5% |
| 3-H2B(2F,3F)O2 | (5-2) | 7% |
| 1V2-HHB(2F,3F)-O2 | (5-3) | 5% |
| 3-HH1OB(2F,3F)-O2 | (2-2) | 5% |
| 5-DhHB(2F,3F)-O2 | (5-5) | 5% |
| 3-HDhB(2F,3F)-O2 | (5-6) | 5% |
| 3-dhBB(2F,3F)-O2 | (3-5) | 5% |
| 3-HHB(2F,3CL)-O2 | (5-7) | 5% |
| 2-H1OB(2F,3F)-O2 | (2-1) | 8% |
| V-H1OB(2F,3F)-O2 | (2-1) | 5% |
| 3-HH-VFF | (4-1) | 3% |
| V-BB-1 | (4-3) | 10% |
| 1V2-BB-1 | (4-3) | 5% |
| 3-HHB-O1 | (4-5) | 5% |
| 5-B(F)BB-3 | (4-7) | 3% |
| V2-B(F)BB-1 | (4-7) | 3% |
| 2-B(F)BB-2V | (4-7) | 4% |
| 2-H2H-3 | (4) | 5% |

NI=89.6° C.; Tc<−20° C.; Δn=0.125; Δ∈=−3.8; η=26.2 mPa·s; K11=17.2 pN; K33=17.3 pN; VHR-1=98.8%; VHR-2=97.8%; VHR-3=97.5%.

### Example 1

| | | |
|---|---|---|
| 3-HVH-2 | (1) | 5% |
| V-HVH-3 | (1) | 5% |
| 3-H1OB(2F,3F)-O2 | (2-1) | 7% |
| 3-HH1OB(2F,3F)-O2 | (2-2) | 26% |
| 3-BB(2F,3F)-O2 | (3-1) | 15% |
| 2-HH-3 | (4-1) | 15% |
| 3-HH-4 | (4-1) | 4% |
| 3-HH-5 | (4-1) | 3% |
| 1-BB-3 | (4-3) | 4% |
| 3-HHB-1 | (4-5) | 7% |
| 3-HBB-2 | (4-6) | 9% |

NI=75.4° C.; Tc<−20° C.; Δn=0.098; Δ∈=−3.9; Vth=2.09 V; η=23.0 mPa·s; VHR-1=99.2%; VHR-2=98.2%; VHR-3=98.2%.

### Example 2

| | | |
|---|---|---|
| 3-HVH-1 | (1) | 5% |
| 3-HVH-2 | (1) | 5% |
| 3-H1OB(2F,3F)-O2 | (2-1) | 7% |
| 3-HH1OB(2F,3F)-O2 | (2-2) | 16% |
| 3-BB(2F,3F)-O2 | (3-1) | 10% |
| 5-BB(2F,3F)-O4 | (3-1) | 5% |
| 2-HH-3 | (4-1) | 15% |
| 3-HH-4 | (4-1) | 4% |
| 3-HH-5 | (4-1) | 3% |
| 1-BB-5 | (4-3) | 4% |
| 3-HHB-1 | (4-5) | 7% |
| 1V-HBB-2 | (4-6) | 9% |
| 2-HHB(2F,3F)-O2 | (5-3) | 10% |

NI=74.5° C.; Tc<−20° C.; Δn=0.097; Δ∈=−3.3; Vth=2.23 V; η=23.4 mPa·s; VHR-1=99.2%; VHR-2=98.2%; VHR-3=98.0%.

### Example 3

| | | |
|---|---|---|
| 3-HVH-2 | (1) | 5% |
| 3-HVH-3 | (1) | 5% |
| 5-H1OB(2F,3F)-O2 | (2-1) | 9% |
| 3-HH1OB(2F,3F)-O2 | (2-2) | 10% |
| 5-HH1OB(2F,3F)-O2 | (2-2) | 8% |
| 2-BB(2F,3F)-O2 | (3-1) | 7% |
| 3-BB(2F,3F)-O2 | (3-1) | 5% |
| 2-HH-3 | (4-1) | 15% |
| 3-HH-4 | (4-1) | 4% |
| 3-HH-5 | (4-1) | 3% |
| V2-BB-1 | (4-3) | 4% |
| 3-HHB-1 | (4-5) | 4% |
| 3-HBB-2 | (4-6) | 5% |
| 5-B(F)BB-2 | (4-7) | 4% |
| 5-HBBH-3 | (4-11) | 3% |
| V2-HB(2F,3F)-O2 | (5-1) | 3% |
| 3-DhH1OB(2F,3F)-O2 | (—) | 6% |

NI=75.8° C.; Tc<−20° C.; Δn=0.099; Δ∈=−3.3; Vth=2.21 V; η=24.9 mPa·s; VHR-1=99.2%; VHR-2=98.1%; VHR-3=98.1%.

### Example 4

| | | |
|---|---|---|
| 3-HVH-1 | (1) | 8% |
| 2-HH1OB(2F,3F)-O2 | (2-2) | 4% |
| 3-HH1OB(2F,3F)-O2 | (2-2) | 20% |
| 3-BB(2F,3F)-O2 | (3-1) | 5% |
| V2-BB(2F,3F)-O1 | (3-1) | 6% |
| 4-dhBB(2F,3F)-O2 | (3-5) | 5% |
| 2-HH-3 | (4-1) | 14% |
| 5-HB-3 | (4-2) | 5% |
| V2-HB-1 | (4-2) | 5% |
| 2-HHB-1 | (4-5) | 4% |
| 3-HHB-1 | (4-5) | 6% |
| 3-HHB-O1 | (4-5) | 4% |
| 1V-HHB-1 | (4-5) | 3% |
| 2-BB(F)B-3 | (4-8) | 3% |
| 5-HB(2F,3F)-O4 | (5-1) | 8% |

NI=75.5° C.; Tc<−20° C.; Δn=0.094; —∈A=−3.0; Vth=2.29 V; η=19.0 mPa·s; VHR-1=99.0%; VHR-2=98.2%; VHR-3=98.1%.

### Example 5

| | | |
|---|---|---|
| 3-HVH-1 | (1) | 5% |
| 2-HH1OB(2F,3F)-O2 | (2-2) | 4% |
| 3-HH1OB(2F,3F)-O2 | (2-2) | 20% |
| 3-BB(2F,3F)-O2 | (3-1) | 5% |
| V2-BB(2F,3F)-O2 | (3-1) | 10% |
| 1V2-BB(2F,3F)-O1 | (3-1) | 4% |
| 3-dhBB(2F,3F)-O2 | (3-5) | 5% |
| 2-HH-3 | (4-1) | 16% |
| 3-HH-4 | (4-1) | 4% |
| 1-BB-3 | (4-3) | 10% |
| 2-HHB-1 | (4-5) | 4% |
| 3-HHB-1 | (4-5) | 6% |
| 3-HHB-3 | (4-5) | 3% |
| 3-HHB-O1 | (4-5) | 4% |

NI=74.8° C.; Tc<−20° C.; Δn=0.104; Δ∈=−3.1; Vth=2.27 V; η=17.2 mPa·s; VHR-1=99.0%; VHR-2=98.1%; VHR-3=98.1%.

### Example 6

| | | |
|---|---|---|
| V-HVH-3 | (1) | 5% |
| 2-HH1OB(2F,3F)-O2 | (2-2) | 4% |
| 3-HH1OB(2F,3F)-O2 | (2-2) | 12% |
| 3-BB(2F,3F)-O2 | (3-1) | 5% |
| V2-BB(2F,3F)-O2 | (3-1) | 10% |
| 4-B(2F,3F)B(2F,3F)-O2 | (3-2) | 3% |
| 2-HH-3 | (4-1) | 17% |
| 3-HH-VFF | (4-1) | 3% |
| 7-HB-1 | (4-2) | 10% |
| 2-HHB-1 | (4-5) | 4% |
| 3-HHB-1 | (4-5) | 6% |
| 3-HHB-3 | (4-5) | 3% |
| 3-HBB(F)B-4 | (4-13) | 5% |
| 1V2-HB(2F,3F)-O3 | (5-1) | 4% |
| 1V2-HHB(2F,3F)-1 | (5-3) | 5% |
| 5-HH2B(2F,3F)-O2 | (5-4) | 4% |

NI=75.7° C.; Tc<+20° C.; Δn=0.090; Δ∈=−2.9; Vth=2.31 V; η=17.0 mPa·s; VHR-1=99.2%; VHR-2=98.1%; VHR-3=98.0%.

### Example 7

| | | |
|---|---|---|
| 3-HVH-2 | (1) | 5% |
| 3-HVH-3 | (1) | 8% |
| V-HVH-3 | (1) | 6% |
| 2-HH1OB(2F,3F)-O2 | (2-2) | 10% |
| 3-HH1OB(2F,3F)-O2 | (2-2) | 18% |
| 3-BB(2F,3F)-O2 | (3-1) | 10% |
| 5-BB(2F,3F)-O2 | (3-1) | 4% |
| 3-dhBB(2F,3F)-O2 | (3-5) | 10% |
| 3-HH-V | (4-1) | 10% |
| 1-BB-5 | (4-3) | 6% |
| 5-B(F)BB-2 | (4-7) | 3% |
| 5-HB(2F,3F)-O2 | (5-1) | 7% |
| V-HB(2F,3F)-O4 | (5-1) | 3% |

NI=70.2° C.; Tc<−20° C.; Δn=0.105; Δ∈=−4.4; Vth=1.84 V; n=15.6 mPa·s; VHR-1=99.2%; VHR-2=98.2%; VHR-3=98.0%.

### Example 8

| | | |
|---|---|---|
| 3-HVH-3 | (1) | 6% |
| 2-HH1OB(2F,3F)-O2 | (2-2) | 8% |
| 3-HH1OB(2F,3F)-O2 | (2-2) | 18% |
| 5-BB(2F,3F)-O2 | (3-1) | 10% |
| 4O-B(2F,3F)B(2F,3F)-O3 | (3-2) | 3% |
| 3-HH-V | (4-1) | 15% |
| 3-HH-V1 | (4-1) | 10% |
| 5-B(F)BB-2 | (4-7) | 4% |
| 3-HB(F)HH-5 | (4-10) | 4% |
| V-HB(2F,3F)-O2 | (5-1) | 10% |
| V-HB(2F,3F)-O3 | (5-1) | 7% |
| V2-HHB(2F,3F)-O2 | (5-3) | 5% |

NI=70.6° C.; Tc<−20° C.; Δn=0.090; Δ∈=−4.1; Vth=1.90 V; η=16.9 mPa·s; VHR-1=99.1%; VHR-2=98.2%; VHR-3=98.1%.

### Example 9

| | | |
|---|---|---|
| 3-HVH-1 | (1) | 8% |
| 3-H1OB(2F,3F)-O2 | (2-1) | 7% |
| 5-H1OB(2F,3F)-O2 | (2-1) | 3% |
| 2-HH1OB(2F,3F)-O2 | (2-2) | 10% |
| 3-HH1OB(2F,3F)-O2 | (2-2) | 7% |
| 3-BB(2F,3F)-O4 | (3-1) | 4% |
| 1V2-HBB(2F,3F)-O2 | (3-4) | 3% |
| 2-HH-3 | (4-1) | 6% |
| 3-HH-4 | (4-1) | 5% |
| 3-HB-O1 | (4-2) | 5% |
| 3-HHB-1 | (4-5) | 4% |
| 3-HHB-O1 | (4-5) | 4% |
| 1V-HHB-1 | (4-5) | 3% |
| 1V-HBB-2 | (4-6) | 7% |
| 3-HB(F)BH-3 | (4-12) | 4% |
| 1V2-HB(2F,3F)-O2 | (5-1) | 3% |
| 1V2-HB(2F,3F)-O4 | (5-1) | 7% |
| 3-HHB(2F,3F)-1 | (5-3) | 7% |
| 5-HH1OCro(7F,8F)-5 | (5-9) | 3% |

NI=90.8° C.; Tc<−20° C.; Δn=0.100; Δ∈=−4.5; Vth=2.15 V; η=24.3 mPa·s; VHR-1=99.0%; VHR-2=98.1%; VHR-3=98.0%.

### Example 10

| | | |
|---|---|---|
| 3-HVH-3 | (1) | 3% |
| 2-H1OB(2F,3F)-O2 | (2-1) | 7% |
| 2-HH1OB(2F,3F)-O2 | (2-2) | 10% |
| 3-HH1OB(2F,3F)-O2 | (2-2) | 17% |
| 3-BB(2F,3F)-O2 | (3-1) | 4% |
| 2-HH-5 | (4-1) | 5% |
| V2-HB-1 | (4-2) | 4% |
| V2-BB-1 | (4-3) | 6% |
| 3-HHB-1 | (4-5) | 4% |
| 3-HHB-3 | (4-5) | 8% |
| 3-HHB-O1 | (4-5) | 4% |
| 3-HBB-2 | (4-6) | 9% |
| 3-H2B(2F,3F)-O2 | (5-2) | 10% |
| 3-HDhB(2F,3F)-O2 | (5-6) | 9% |

NI=90.6° C.; Tc<−20° C.; Δn=0.110; Δ∈=−4.6; Vth=2.11 V; η=24.2 mPa·s; VHR-1=99.0%; VHR-2=98.2%; VHR-3=98.1%.

### Example 11

| | | |
|---|---|---|
| 3-HVH-1 | (1) | 7% |
| 2-HH1OB(2F,3F)-O2 | (2-2) | 8% |
| 1V2-BB(2F,3F)-O2 | (3-1) | 8% |
| 3-dhBB(2F,3F)-O2 | (3-5) | 3% |
| 2-BB(2F,3F)B-3 | (3-7) | 11% |
| 3-HH-V | (4-1) | 27% |
| 3-HHB-1 | (4-5) | 4% |
| V-HHB(2F,3F)-O1 | (5-3) | 5% |
| V-HHB(2F,3F)-O2 | (5-3) | 10% |
| V-HHB(2F,3F)-O4 | (5-3) | 6% |
| 3-HDhB(2F,3F)-O2 | (5-6) | 8% |
| 3-Dh1OB(2F,3F)-O2 | (—) | 3% |

NI=85.4° C.; Tc<−20° C.; Δn=0.100; Δ∈=−4.0; Vth=2.05V; η=17.6 mPa·s; VHR-1=99.2%; VHR-2=98.2%; VHR-3=98.1%.

### Example 12

| | | |
|---|---|---|
| 3-HVH-2 | (1) | 7% |
| 2-HH1OB(2F,3F)-O2 | (2-2) | 8% |
| 3-BB(2F,3F)-O2 | (3-1) | 8% |
| V2-HBB(2F,3F)-O2 | (3-4) | 6% |
| 2-BB(2F,3F)B-4 | (3-7) | 11% |
| 4-HH-V | (4-1) | 10% |
| 5-HH-V | (4-1) | 10% |
| V2-HHB-1 | (4-5) | 4% |
| 5-B(F)BB-2 | (4-7) | 8% |
| 3-HB(2F,3F)-O2 | (5-1) | 7% |
| 2-HHB(2F,3F)-1 | (5-3) | 6% |
| V-HHB(2F,3F)-O2 | (5-3) | 6% |
| V-HHB(2F,3F)-O4 | (5-3) | 6% |
| 3-DhHB(2F,3F)-O2 | (5-5) | 3% |

NI=86.4° C.; Tc<−20° C.; Δn=0.120; Δ∈=−3.4; Vth=2.17 V; η=18.3 mPa·s; VHR-1=99.2%; VHR-2=98.2%; VHR-3=98.2%.

### Example 13

| | | |
|---|---|---|
| 3-HVH-2 | (1) | 5% |
| 2-HH1OB(2F,3F)-O2 | (2-2) | 7% |
| 3-HH1OB(2F,3F)-O2 | (2-2) | 18% |
| 3-BB(2F,3F)-O2 | (3-1) | 9% |
| 2-HH-3 | (4-1) | 20% |
| 3-HH-4 | (4-1) | 8% |
| 3-HH-O1 | (4-1) | 3% |
| 3-HB-O2 | (4-2) | 3% |
| 1-BB-3 | (4-3) | 5% |
| 3-HHB-1 | (4-5) | 4% |
| 3-HHB-3 | (4-5) | 10% |
| V-HHB-3 | (4-5) | 3% |
| 3-HB(2F,3F)-O4 | (5-1) | 5% |

NI=75.0° C.; Tc<−20° C.; Δn=0.080; Δ∈=−2.3; Vth=2.61V; η=13.6 mPa·s; VHR-1=99.0%; VHR-2=98.1%; VHR-3=98.1%.

### Example 14

| | | |
|---|---|---|
| V-HVH-3 | (1) | 5% |
| 2-HH1OB(2F,3F)-O2 | (2-2) | 7% |
| 3-HH1OB(2F,3F)-O2 | (2-2) | 14% |
| 3-BB(2F,3F)-O2 | (3-1) | 9% |
| 5-BB(2F,3F)-O2 | (3-1) | 5% |
| 2-HH-3 | (4-1) | 15% |
| 3-HH-4 | (4-1) | 8% |
| 3-HH-5 | (4-1) | 3% |
| 3-HB-O1 | (4-2) | 3% |
| 1-BB-5 | (4-3) | 10% |
| 3-HHEH-3 | (4-4) | 4% |
| 3-HHB-3 | (4-5) | 11% |
| 3-HHB-O1 | (4-5) | 3% |
| 4-HHB(2F,3CL)-O2 | (5-7) | 3% |

NI=75.8° C.; Tc<−20° C.; Δn=0.090; Δ∈=−2.0; Vth=2.68 V; η=15.9 mPa·s; VHR-1=99.0%; VHR-2=98.0%; VHR-3=98.0%.

### Example 15

| | | |
|---|---|---|
| 3-HVH-1 | (1) | 5% |
| 3-H1OB(2F,3F)-O2 | (2-1) | 7% |
| 2-HH1OB(2F,3F)-O2 | (2-2) | 3% |
| 2-HBB(2F,3F)-O2 | (3-4) | 4% |
| 3-HBB(2F,3F)-O2 | (3-4) | 7% |
| 4-HBB(2F,3F)-O2 | (3-4) | 5% |
| V-HBB(2F,3F)-O2 | (3-4) | 8% |
| V-HBB(2F,3F)-O4 | (3-4) | 4% |
| V2-HBB(2F,3CL)-O2 | (3-6) | 5% |
| 2-HH-3 | (4-1) | 20% |
| 3-HH-4 | (4-1) | 5% |
| 1-BB-5 | (4-3) | 3% |
| 3-HHB-1 | (4-5) | 5% |
| 3-H2B(2F,3F)-O2 | (5-2) | 14% |
| 3-HDhB(2F,3F)-O2 | (5-6) | 5% |

NI=75.5° C.; Tc<−20° C.; Δn=0.100; Δ∈=−3.7; Vth=1.95 V; η=19.2 mPa·s; VHR-1=99.2%; VHR-2=98.2%; VHR-3=98.1%.

### Example 16

| | | |
|---|---|---|
| 3-HVH-1 | (1) | 5% |
| 3-H1OB(2F,3F)-O2 | (2-1) | 7% |
| 2-HH1OB(2F,3F)-O2 | (2-2) | 3% |
| 3-HEB(2F,3F)B(2F,3F)-O2 | (3-3) | 5% |
| 2-HBB(2F,3F)-O2 | (3-4) | 3% |
| 3-HBB(2F,3F)-O2 | (3-4) | 4% |
| 5-HBB(2F,3F)-O2 | (3-4) | 5% |
| V-HBB(2F,3F)-O2 | (3-4) | 4% |
| V-HBB(2F,3F)-O4 | (3-4) | 4% |
| 2-BB(2F,3F)B-3 | (3-7) | 4% |
| 2-HH-3 | (4-1) | 15% |
| 3-HH-4 | (4-1) | 5% |
| 7-HB-1 | (4-2) | 3% |
| 3-HHB-3 | (4-5) | 5% |
| 3-HHEBH-4 | (4-9) | 4% |
| 3-HB(2F,3F)-O2 | (5-1) | 10% |
| V-HB(2F,3F)-O3 | (5-1) | 4% |
| 3-HHB(2F,3F)-1 | (5-3) | 5% |
| 3-H1OCro(7F,8F)-5 | (5-8) | 5% |

NI=75.3° C.; Tc<−20° C.; Δn=0.100; Δ∈=−3.6; Vth=1.99 V; η=24.4 mPa·s; VHR-1=99.2%; VHR-2=98.1%; VHR-3=98.1%.

The compositions in Examples 1 to 16 have a smaller viscosity in comparison with Comparative Example 1. Accordingly, the liquid crystal composition of the invention has further excellent characteristics.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

### INDUSTRIAL APPLICABILITY

A liquid crystal composition of the invention satisfies at least one of characteristics such as a high maximum temperature of a nematic phase, a low minimum temperature of the nematic phase, a small viscosity, a suitable optical anisotropy, a large negative dielectric anisotropy, a large specific resistance, a high stability to ultraviolet light, a high stability to heat or the like, or has a suitable balance regarding at least two of the characteristics. A liquid crystal display device including the composition has characteristics such as a short response time, a large voltage holding ratio, a low threshold voltage, a large contrast ratio, a long service life and so forth, and thus can be used for a liquid crystal projector, a liquid crystal television and so forth.

What is claimed is:

1. A liquid crystal composition that has a negative dielectric anisotropy and contains at least one compound selected from the group consisting of compounds represented by formula (1) as a first component, at least one compound selected from the group consisting of compounds represented by formula (2) as a second component, and at least one compound selected from the group consisting of compounds represented by formula (3) as a third component: 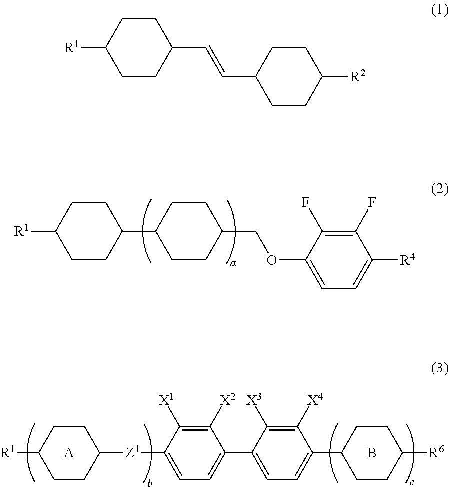
wherein, in formula (1) to formula (3), R¹, R², R³, R⁴, R⁵ and R⁶ are independently alkyl having 1 to 12 carbons, alkoxy having 1 to 12 carbons, alkenyl having 2 to 12 carbons or alkenyloxy having 2 to 12 carbons; ring A and ring B are independently 1,4-cyclohexylene, 1,4-phenylene or tetrahydropyran-2,5-diyl; X¹ and X² are independently hydrogen, fluorine or chlorine; X³ and X⁴ are independently fluorine or chlorine; Z¹ is a single bond, —CH₂CH₂—, —CH₂O—, —OCH₂—, —COO— or —OCO—; a and c are independently 0 or 1; b is 0, 1 or 2; and a sum of b and c is 0, 1 or 2.

2. The liquid crystal composition according to claim 1, containing at least one compound selected from the group consisting of compounds represented by formula (2-1) and formula (2-2) as the second component: 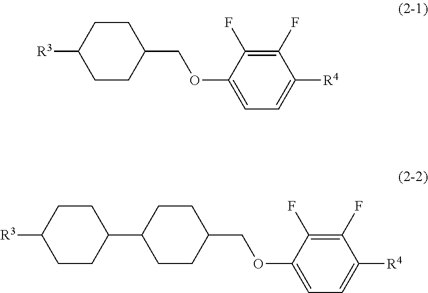
wherein, in formula (2-1) and formula (2-2), R³ and R⁴ are independently alkyl having 1 to 12 carbons, alkoxy having 1 to 12 carbons, alkenyl having 2 to 12 carbons or alkenyloxy having 2 to 12 carbons.

3. The liquid crystal composition according to claim 1, containing at least one compound selected from the group consisting of compounds represented by formula (3-1) to formula (3-7) as the third component: 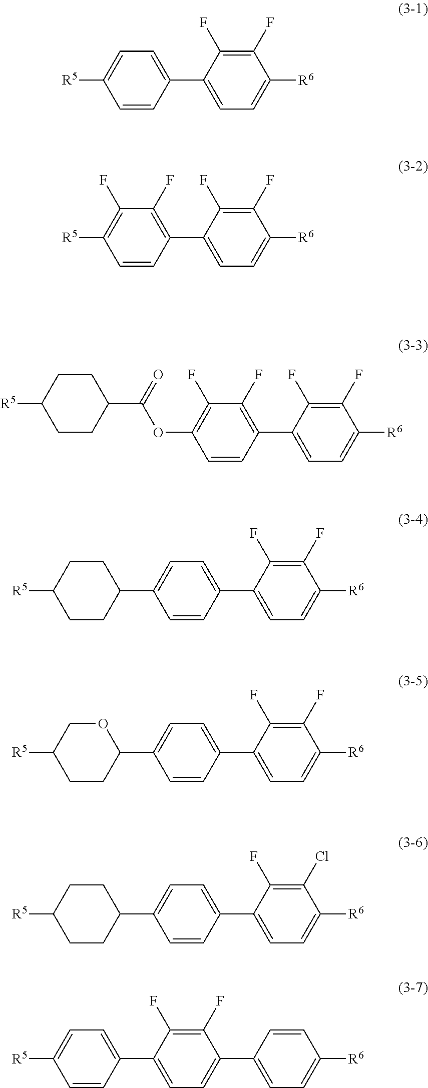
wherein, in formula (3-1) to formula (3-7), R⁵ and R⁶ are independently alkyl having 1 to 12 carbons, alkoxy having 1 to 12 carbons, alkenyl having 2 to 12 carbons or alkenyloxy having 2 to 12 carbons.

4. The liquid crystal composition according to claim 1, wherein a ratio of the first component is in the range of 3% by weight to 30% by weight, a ratio of the second component is in the range of 5% by weight to 50% by weight and a ratio of the third component is in the range of 3% by weight to 50% by weight, based on the weight of the liquid crystal composition.

5. The liquid crystal composition according to claim 1, containing at least one compound selected from the group consisting of compounds represented by formula (4) as a fourth component: 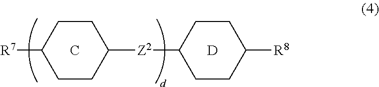
wherein, in formula (4), R⁷ and R⁸ are independently alkyl having 1 to 12 carbons, alkoxy having 1 to 12 carbons, alkenyl having 2 to 12 carbons, alkyl having 1 to 12 carbons in which at least one of hydrogen is replaced by fluorine, or alkenyl having 2 to 12 carbons in which at least one of hydrogen is replaced by fluorine; ring C and ring D are independently 1,4-cyclohexylene, 1,4-phenylene, 2-fluoro-1,4-phenylene or 2,5-difluoro-1,4-phenylene; Z² is a single bond, —CH₂CH₂—, —CH₂O—, —OCH₂—, —COO— or —OCO—; and d is 1, 2 or 3.

6. The liquid crystal composition according to claim 5, containing at least one compound selected from the group consisting of compounds represented by formula (4-1) to formula (4-13) as the fourth component: 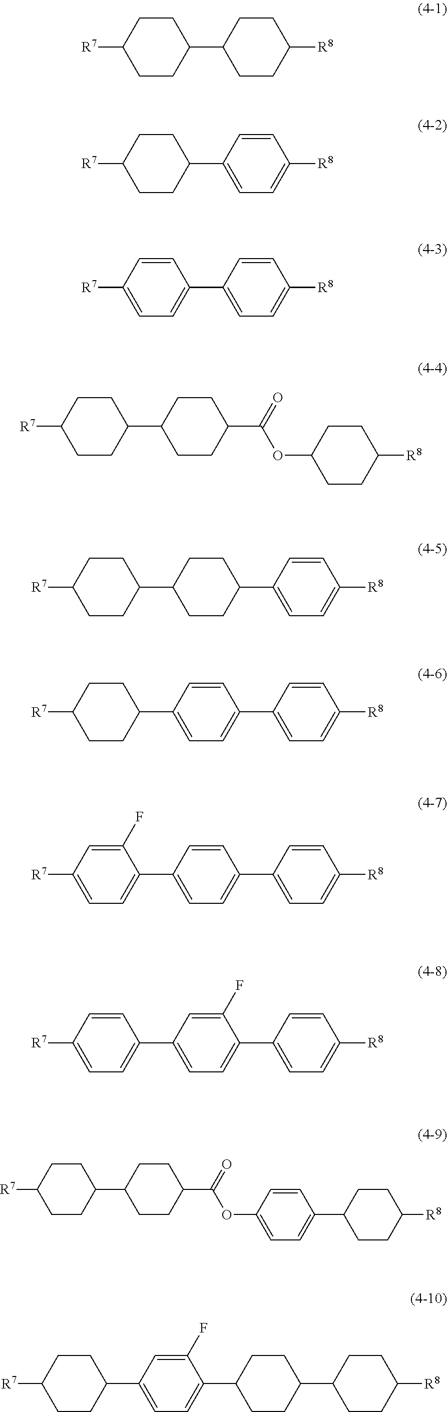 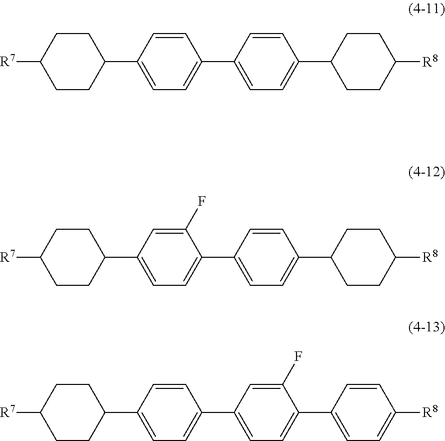
wherein, in formula (4-1) to formula (4-13), R⁷ and R⁸ are independently alkyl having 1 to 12 carbons, alkoxy having 1 to 12 carbons, alkenyl having 2 to 12 carbons, alkyl having 1 to 12 carbons in which at least one of hydrogen is replaced by fluorine, or alkenyl having 2 to 12 carbons in which at least one of hydrogen is replaced by fluorine.

7. The liquid crystal composition according to claim 5, wherein a ratio of the fourth component is in the range of 5% by weight to 80% by weight based on the weight of the liquid crystal composition.

8. The liquid crystal composition according to claim 1, containing at least one compound selected from the group consisting of compounds represented by formula (5) as a fifth component: 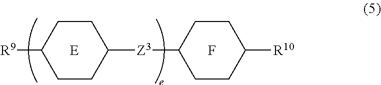
wherein, in formula (5), R⁹ and R¹⁰ are independently alkyl having 1 to 12 carbons, alkoxy having 1 to 12 carbons, alkenyl having 2 to 12 carbons or alkenyloxy having 2 to 12 carbons; ring E is 1,4-cyclohexylene, 1,4-cyclohexenylene or tetrahydropyran-2,5-diyl; ring F is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl or 7,8-difluorochroman-2,6-diyl; Z³ is a single bond, —CH₂CH₂—, —CH₂O—, —OCH₂—, —COO— or —OCO—; e is 1, 2 or 3; and when ring F is 2,3-difluoro-1,4-phenylene, Z³ is a single bond, —CH₂CH₂—, —COO— or —OCO—.

9. The liquid crystal composition according to claim 8, containing at least one compound selected from the group consisting of compounds represented by formula (5-1) to formula (5-9) as the fifth component: 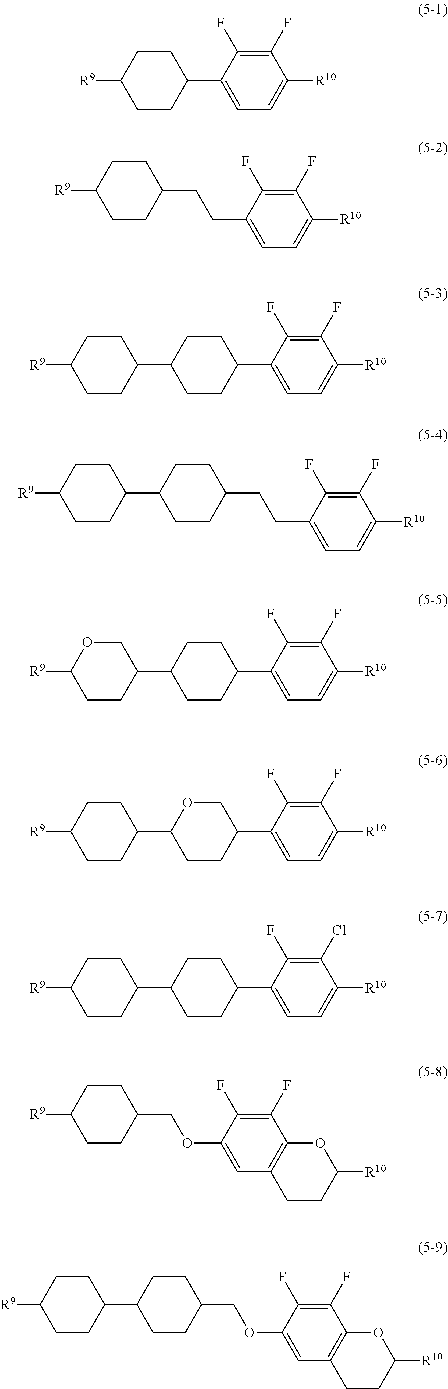
wherein, in formula (5-1) to formula (5-9), R⁹ and R¹⁰ are independently alkyl having 1 to 12 carbons, alkoxy having 1 to 12 carbons, alkenyl having 2 to 12 carbons or alkenyloxy having 2 to 12 carbons.

10. The liquid crystal composition according to claim 8, wherein a ratio of the fifth component is in the range of 3% by weight to 50% by weight based on the weight of the liquid crystal composition.

11. The liquid crystal composition according to claim 5, containing at least one compound selected from the group consisting of compounds represented by formula (5) as a fifth component: 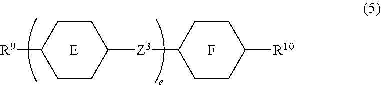
wherein, in formula (5), R⁹ and R¹⁰ are independently alkyl having 1 to 12 carbons, alkoxy having 1 to 12 carbons, alkenyl having 2 to 12 carbons or alkenyloxy having 2 to 12 carbons; ring E is 1,4-cyclohexylene, 1,4-cyclohexenylene or tetrahydropyran-2,5-diyl; ring F is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl or 7,8-difluorochroman-2,6-diyl; Z³ is a single bond, —CH₂CH₂—, —CH₂O—, —OCH₂—, —COO— or —OCO—; e is 1, 2 or 3; and when ring F is 2,3-difluoro-1,4-phenylene, Z³ is a single bond, —CH₂CH₂—, —COO— or —OCO—.

12. The liquid crystal composition according to claim 1, containing at least one polymerizable compound selected from the group consisting of compounds represented by formula (6) as an additive component: 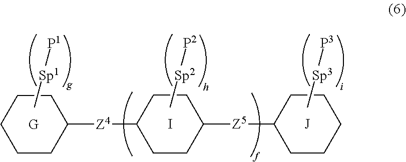
wherein, in formula (6), ring G and ring J are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one of hydrogen may be replaced by halogen, alkyl having 1 to 12 carbons, alkoxy having 1 to 12 carbons, or alkyl having 1 to 12 carbons in which at least one of hydrogen is replaced by halogen; ring I is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one of hydrogen may be replaced by halogen, alkyl having 1 to 12 carbons, alkoxy having 1 to 12 carbons, or alkyl having 1 to 12 carbons in which at least one of hydrogen is replaced by halogen; Z⁴ and Z⁵ are independently a single bond or alkylene having 1 to 10 carbons, and in the alkylene, at least one of —CH₂— may be replaced by —O—, —CO—, —COO— or —OCO—, at least one of —CH₂—CH₂— may be replaced by —CH═CH—, —C(CH₃)═CH—, —CH═C(CH₃)— or —C(CH₃)═C(CH₃)—, and in the groups, at least one of hydrogen may be replaced by fluorine or chlorine; P¹, P² and P³ are a polymerizable group; Sp¹, Sp² and Sp³ are independently a single bond or alkylene having 1 to 10 carbons, and in the alkylene, at least one of —CH₂— may be replaced by —O—, —COO—, —OCO— or —OCOO—, at least one of —CH₂—CH₂— may be replaced by —CH═CH— or —C≡C—, and in the groups, at least one of hydrogen may be replaced by fluorine or chlorine; f is 0, 1 or 2; g, h and i are independently 0, 1, 2, 3 or 4; and a sum of g, h and i is 1 or more.

13. The liquid crystal composition according to claim 12, wherein, in formula (6), P¹, P² and P³ are independently a polymerizable group selected from the group consisting of groups represented by formula (P-1) to formula (P-6): 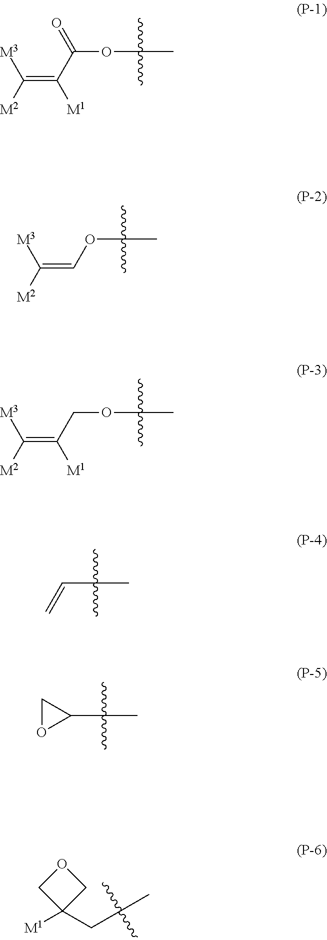
wherein, in formula (P-1) to formula (P-6), M¹, M², and M³ are independently hydrogen, fluorine, alkyl having 1 to 5 carbons, or alkyl having 1 to 5 carbons in which at least one of hydrogen is replaced by halogen;
in formula (6), when all of g pieces of P¹ and i pieces of P³ is a group represented by formula (P-4), at least one of g pieces of Sp¹ and i pieces of Sp³ is alkylene in which at least one of —CH₂— is replaced by —O—, —COO—, —OCO— or —OCOO—.

14. The liquid crystal composition according to claim 12, containing at least one polymerizable compound selected from the group consisting of compounds represented by formula (6-1) to formula (6-27) as the additive component: 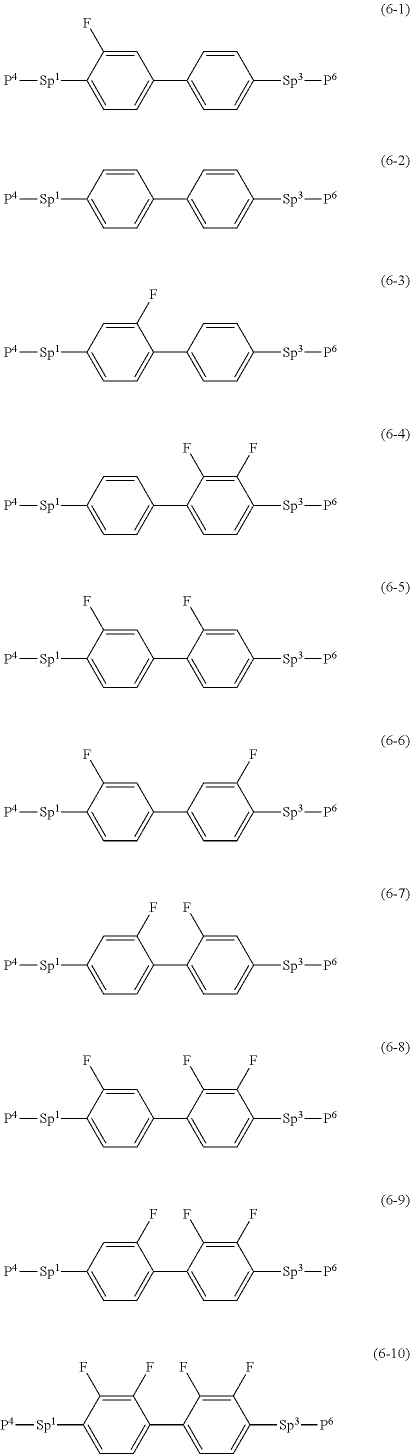 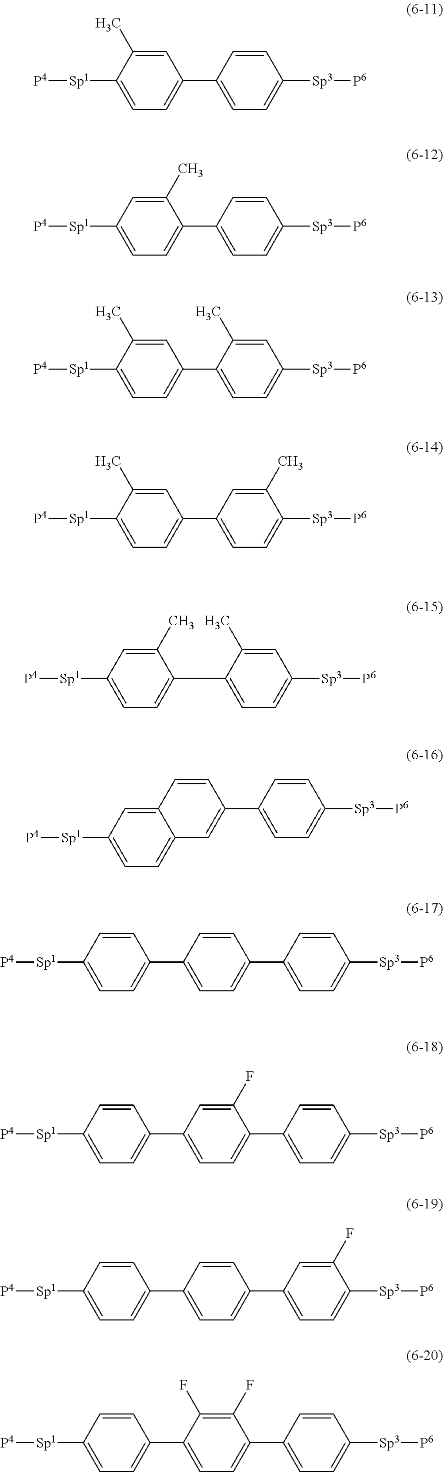 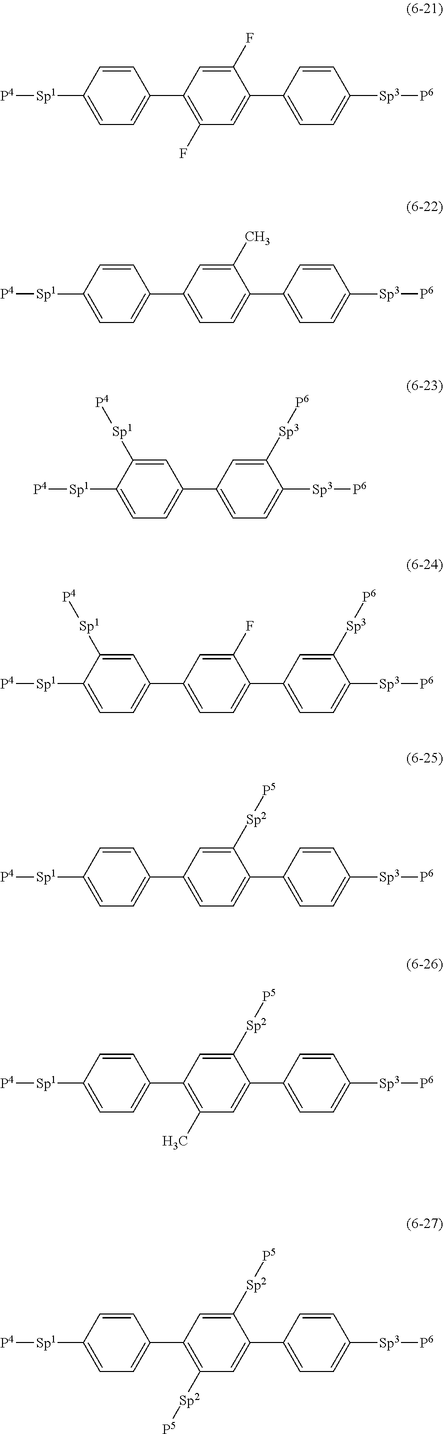
wherein, in formula (6-1) to formula (6-27), P⁴, P⁵ and P⁶ are independently a polymerizable group selected from the group consisting of groups represented by formula (P-1) to formula (P-3): 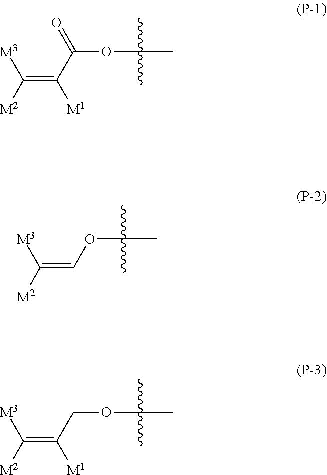
wherein, in formula (P-1) to formula (P-3), M¹, M² and M³ are independently hydrogen, fluorine, alkyl having 1 to 5 carbons, or alkyl having 1 to 5 carbons in which at least one of hydrogen is replaced by halogen; Sp¹, Sp², and Sp^{a} are independently a single bond or alkylene having 1 to 10 carbons, and in the alkylene, at least one of —CH₂— may be replaced by —O—, —COO—, —OCO— or —OCOO—, at least one of —CH₂—CH₂— may be replaced by —CH═CH— or —C≡C—, and in the groups, at least one of hydrogen may be replaced by fluorine or chlorine.

15. The liquid crystal composition according to claim 12, wherein a ratio of the additive component is in the range of 0.03% by weight to 10% by weight based on the weight of the liquid crystal composition.

16. A liquid crystal display device, including the liquid crystal composition according to claim 1.

17. The liquid crystal display device according to claim 16, wherein an operating mode in the liquid crystal display device is an IPS mode, a VA mode, an FFS mode or an ETA mode, and a driving mode in the liquid crystal display device is an active matrix mode.

18. A liquid crystal display device having a polymer sustained alignment mode, wherein the liquid crystal display device includes the liquid crystal composition according to claim 12, or a polymerizable compound in the liquid crystal composition is polymerized.

19. A method for using the liquid crystal composition according to claim 1, including injecting the liquid crystal composition into a liquid crystal display device.

20. A method for using the liquid crystal composition according to claim 1, including injecting the liquid crystal composition into a liquid crystal display device having a polymer sustained alignment mode.
